(19) United States
(12) Patent Application Publication
(10) Pub. No.: US 2025/0347886 A1
(43) Pub. Date: Nov. 13, 2025

(54) PHOTOGRAPHING LENS ASSEMBLY

(71) Applicant: ZHEJIANG SUNNY OPTICS CO.,LTD., Yuyao (CN)

(72) Inventors: Kang LI, Yuyao (CN); Tingting GONG, Yuyao (CN); Litong SONG, Yuyao (CN); Weifang LI, Yuyao (CN); Yinfang JIN, Yuyao (CN); Liefeng ZHAO, Yuyao (CN)

(73) Assignee: ZHEJIANG SUNNY OPTICS CO.,LTD., Yuyao (CN)

(21) Appl. No.: 19/202,767

(22) Filed: May 8, 2025

(30) Foreign Application Priority Data
May 8, 2024 (CN) 202410565387.9

(51) Int. Cl. G02B 7/02; G02B 9/62; G02B 13/18; G03B 17/12

(52) U.S. Cl. CPC G02B 7/021; G02B 9/62; G02B 13/18; G03B 17/12

(57) ABSTRACT

Disclosed is a photographing lens assembly. The photographing lens assembly includes a lens barrel and a six-piece lens group and a spacer group that are arranged in the lens barrel; the six-piece lens group includes a first lens having a negative refractive power, a second lens having a positive refractive power, a third lens having a positive refractive power, a fourth lens having a negative refractive power, a fifth lens having a positive refractive power, and a sixth lens having a negative refractive power that are arranged in sequence from an object side to an image side along an optical axis; the spacer group includes a fourth spacer and a fifth spacer; and the photographing lens assembly satisfies: 2.7<f/(f5+f6)<−1.2, −2.0<f1/f3<−1.7, 0.5<(EP45+CP5)/(CT5+T45)<1.4, and 2.2<CT5/EP45<3.4 photographing lens assembly.

### CROSS-REFERENCE TO RELATED APPLICATION(S)

This application claims priority to Chinese Patent Application No. 202410565387.9 filed on February May 8, 2024, the entire contents of each of which are incorporated herein by reference for all purposes. No new matter has been introduced.

### FIELD

The disclosure relates to the field of optical devices, and particularly relates to a six-piece photographing lens assembly.

### BACKGROUND

As consumption demand has changed over recent years, requirements for photographing lens assemblies have gradually become complex and diversified. The photographing lens assemblies show different performances in different application scenarios.

At present, six-piece photographing lens assemblies, a type of prevailing photographing lens assemblies, have been broadly applied to mobile phones, security and protection, automobiles, unmanned aerial vehicles, and other fields. A fifth lens of the six-piece photographing lens assembly is designed to have a thicker center and a thinner edge. Consequently, a spacing distance between a non-effective diameter portion of the fifth lens and a non-effective diameter portion of a sixth lens in a direction along the optical axis is greater than a spacing distance between non-effective diameter portions of any two adjacent lenses from a first lens to the fifth lens in the direction along the optical axis. The fifth lens and the sixth lens are likely to tilt, deform, etc. during assembly, thereby affecting assembly stability of the photographing lens assembly.

### SUMMARY

Some embodiments of the disclosure provides a photographing lens assembly that is able to at least solve or partially solve at least one problem or other problems in the prior art.

In an embodiment of the disclosure, a photographing lens assembly is provided. The photographing lens assembly includes a lens barrel, and a six-piece lens group and a spacer group that are arranged in the lens barrel. The six-piece lens group includes a first lens having a negative refractive power, a second lens having a positive refractive power, a third lens having a positive refractive power, a fourth lens having a negative refractive power, a fifth lens having a positive refractive power, and a sixth lens having a negative refractive power that are arranged in sequence from an object side to an image side along an optical axis. The spacer group includes a fourth spacer arranged on and in contact with an image-side surface of the fourth lens and a fifth spacer arranged on and in contact with an image-side surface of the fifth lens. A spacing distance between a non-effective diameter portion of the fifth lens and a non-effective diameter portion of a sixth lens in a direction along the optical axis is greater than a spacing distance between non-effective diameter portions of any two adjacent lenses from a first lens to the fifth lens in the direction along the optical axis. An effective focal length f1 of the first lens and an effective focal length f3 of the third lens satisfy: −2.0<f1/f3<−1.7. A total effective focal length f of the photographing lens assembly, an effective focal length f5 of the fifth lens, and an effective focal length f6 of the sixth lens satisfy: −2.7<f/(f5+f6)<−1.2. A center thickness CT5 of the fifth lens on the optical axis and a spacing EP45 between the fourth spacer and the fifth spacer along the optical axis satisfy: 2.2<CT5/EP45<3.4. An air spacing T45 between the fourth lens and the fifth lens on the optical axis, a center thickness CT5 of the fifth lens on the optical axis, a spacing EP45 between the fourth spacer and the fifth spacer along the optical axis, and a maximum thickness CP5 of the fifth spacer along the optical axis satisfy: 0.5<(EP45+CP5)/(CT5+T45)<1.4.

According to an exemplary embodiment of the disclosure, the spacer group further includes a first spacer arranged on and in contact with an image-side surface of the first lens. A spacing EP01 between an object-side end surface of the lens barrel and the first spacer along the optical axis, a center thickness CT1 of the first lens on the optical axis, and an air spacing T12 between the first lens and the second lens on the optical axis satisfy: 1.0<EP01/(CT1+T12)<2.7.

According to an exemplary embodiment of the disclosure, the spacer group further includes a first spacer arranged on and in contact with an image-side surface of the first lens. An effective focal length f1 of the first lens and a curvature radius R2 of the image-side surface of the first lens satisfy: 0.8<f1/R2<1.8. An inner diameter d1m of the image-side surface of the first spacer and an outer diameter D1m of an image-side surface of the first spacer satisfy: 1.8<D1m/d1m<2.6.

According to an exemplary embodiment of the disclosure, the spacer group further includes a second spacer arranged on and in contact with an image-side surface of the second lens. A combined focal length f345 of the third lens, the fourth lens, and the fifth lens, an inner diameter d2m of an image-side surface of the second spacer, and an inner diameter d5s of an object-side surface of the fifth spacer satisfy: 1.1<(d5s−d2m)/f345<1.8.

According to an exemplary embodiment of the disclosure, the spacer group further includes a first spacer arranged on and in contact with an image-side surface of the first lens and a second spacer arranged on and in contact with an image-side surface of the second lens. A center thickness CT2 of the second lens on the optical axis, an air spacing T23 between the second lens and the third lens on the optical axis, a spacing EP12 between the first spacer and the second spacer along the optical axis, and a maximum thickness CP2 of the second spacer along the optical axis satisfy: 1.7<(CT2+T23)/(EP12+CP2)<3.3.

According to an exemplary embodiment of the disclosure, the spacer group further includes a second spacer arranged on and in contact with an image-side surface of the second lens and a third spacer arranged on and in contact with an image-side surface of the third lens. An air spacing T23 between the second lens and the third lens on the optical axis, a center thickness CT3 of the third lens on the optical axis, an air spacing T34 between the third lens and the fourth lens on the optical axis, and a spacing EP23 between the second spacer and the third spacer along the optical axis satisfy: 1.0<(EP23+CT3)/(T23+T34)<2.3.

According to an exemplary embodiment of the disclosure, the spacer group further includes a second spacer arranged on and in contact with an image-side surface of the second lens, and a third spacer arranged on and in contact with an image-side surface of the third lens. An inner diameter d2m of an image-side surface of the second spacer, an outer diameter D2m of the image-side surface of the second spacer, an inner diameter d3m of ah image-side surface of the third spacer, and an outer diameter D3m of the image-side surface of the third spacer satisfy: 1.4<(D2m−d2m)/(D3m−d3m)<5.3.

According to an exemplary embodiment of the disclosure, the spacer group further includes a third spacer arranged on and in contact with an image-side surface of the third lens. An air spacing T34 between the third lens and the fourth lens on the optical axis, a center thickness CT4 of the fourth lens on the optical axis, and a maximum thickness CP3 of the third spacer along the optical axis satisfy: 0.4<CP3/(T34+CT4)<0.8.

According to an exemplary embodiment of the disclosure, the spacer group further includes a third spacer arranged on and in contact with an image-side surface of the third lens. A center thickness CT3 of the third lens on the optical axis, an outer diameter D3m of the image-side surface of the third spacer, and a spacing EP34 between the third spacer and the fourth spacer along the optical axis satisfy: 3.0<D3m/(EP34+CT3)<4.5.

According to an exemplary embodiment of the disclosure, the spacer group further includes a third spacer arranged on and in contact with an image-side surface of the third lens. An effective focal length f3 of the third lens, an effective focal length f4 of the fourth lens, an inner diameter d3s of an object-side surface of the third spacer, and an inner diameter d4s of an object-side surface of the fourth spacer satisfy: −2.0<f4/f3+d4s/d3s<−0.5.

According to an exemplary embodiment of the disclosure, the spacer group further includes a fifth auxiliary spacer arranged on and in contact with an image-side surface of the fifth spacer. The effective focal length f5 of the fifth lens, the effective focal length f6 of the sixth lens, and an inner diameter d5bs of an object-side surface of the fifth auxiliary spacer satisfy: −0.5<(f5+f6)/d5bs<0.

According to an exemplary embodiment of the disclosure, a maximum length L of the lens barrel in the direction along the optical axis, the total effective focal length f of the photographing lens assembly, and an f-number FNO of the photographing lens assembly satisfy: 3.9<L/f×FNO<4.8.

According to an exemplary embodiment of the disclosure, a maximum effective semi-diameter DT52 of the image-side surface of the fifth lens, a maximum effective semi-diameter DT61 of an object-side surface of the sixth lens, an inner diameter d5s of an object-side surface of the fifth spacer, and an inner diameter d5m of the image-side surface of the fifth spacer satisfy: 5.0<d5s/DT52+d5m/DT61<6.0.

According to an exemplary embodiment of the disclosure, a distance SG52 from an intersection point between the image-side surface of the fifth lens and the optical axis to the object-side surface of the fifth spacer on the optical axis, a distance SG61 from an intersection point between an object-side surface of the sixth lens and the optical axis to the image-side surface of the fifth spacer on the optical axis, and the center thickness CT5 of the fifth lens on the optical axis satisfy: 0.6<(|SG52|+|SG61|)/CT5<1.1.

Six lenses are configured for the photographing lens assembly provided in the disclosure. By controlling refractive power of each lens, the photographing lens assembly is able to satisfy a wide-angle feature. Moreover, the photographing lens assembly satisfies “−2.0<f1/f3<−1.7” and “−2.7<f/(f5+f6)<−1.2”. Thus, trends of light rays in the first lens, the third lens, the fifth lens, and the sixth lens are able to be restricted, and sensitivity of the lenses is able to be reduced. However, in this case, the fifth lens may be designed to have a thicker center and a thinner edge. A thickness ratio of the fifth lens satisfies “2.2<CT5/EP45<3.4”. Moreover, a spacing distance between the non-effective diameter portion of the fifth lens and the non-effective diameter portion of a sixth lens in the direction along the optical axis is greater than a spacing distance between non-effective diameter portions of any two adjacent lenses from the first lens to the fifth lens in the direction along the optical axis. The fifth lens and the sixth lens are likely to tilt, deform, etc. during assembly, thereby affecting assembly stability of the photographing lens assembly. Thus, by controlling the photographing lens assembly to satisfy “0.5<(EP45+CP5)/(CT5+T45)<1.4”, a maximum thickness of the fifth spacer is able to be restricted within a reasonable range, and an overall shape of the sixth lens is able to be indirectly controlled. Thus, the fifth lens and the sixth lens are uniformly stressed during assembly, thereby improving assembly stability of the photographing lens assembly while moldability of the fifth lens and the sixth lens is ensured.

### BRIEF DESCRIPTION OF DRAWINGS

Other features, objectives, and advantages of the disclosure will become more apparent by reading the detailed description on non-limiting examples made with reference to the following accompanying drawings. In the accompanying drawings,

FIG. 1A shows a schematic diagram of parameter labeling for a photographing lens assembly according to the disclosure;

FIG. 1B shows a schematic diagram of another type of parameter labeling for a photographing lens assembly according to the disclosure;

FIG. 2A is a schematic diagram of stress distribution in a case that a photographing lens assembly satisfies (EP45+CP5)/(CT5+T45)=1.34;

FIG. 2B is a schematic diagram of stress distribution in a case that a photographing lens assembly satisfies (EP45+CP5)/(CT5+T45)=0.2;

FIG. 2C is a schematic diagram of stress distribution in a case that a photographing lens assembly satisfies (EP45+CP5)/(CT5+T45)=1.5;

FIG. 3 shows a schematic structural diagram of a photographing lens assembly according to Example 1 of the disclosure;

FIG. 4 shows a schematic structural diagram of a photographing lens assembly according to Example 2 of the disclosure;

FIG. 5 shows a schematic structural diagram of a photographing lens assembly according to Example 3 of the disclosure;

FIGS. 6A to 6C show longitudinal chromatic aberration curves, astigmatism curves, and a distortion curve of a photographing lens assembly according to Example 1, 2, or 3 of the disclosure respectively;

FIG. 7 shows a schematic structural diagram of a photographing lens assembly according to Example 4 of the disclosure;

FIG. 8 shows a schematic structural diagram of a photographing lens assembly according to Example 5 of the disclosure;

FIG. 9 shows a schematic structural diagram of a photographing lens assembly according to Example 6 of the disclosure;

FIGS. 10A to 10C show longitudinal chromatic aberration curves, astigmatism curves, and a distortion curve of a photographing lens assembly according to Example 4, 5, or 6 of the disclosure respectively;

FIG. 11 shows a schematic structural diagram of a photographing lens assembly according to Example 7 of the disclosure;

FIG. 12 shows a schematic structural diagram of a photographing lens assembly according to Example 8 of the disclosure;

FIG. 13 shows a schematic structural diagram of a photographing lens assembly according to Example 9 of the disclosure; and

FIGS. 14A to 14C show longitudinal chromatic aberration curves, astigmatism curves, and a distortion curve of a photographing lens assembly according to Example 7, 8, or 9 of the disclosure respectively.

### DESCRIPTION OF EMBODIMENTS

To better understand the disclosure, various aspects of the disclosure will be described in more details with reference to accompanying drawings. It should be understood that the detailed description is merely description on exemplary embodiments of the disclosure and is not intended to limit the scope of the disclosure in any manner. In the whole description, identical reference numerals represent identical elements.

It should be noted that in the description, expressions of first, second, third, etc. are merely used for distinguishing one feature from another feature, and do not limit the feature. Thus, a first lens discussed below may be referred to as a second lens or a third lens without departing from teachings of the disclosure.

In the accompanying drawings, a thickness, a size, and a shape of a lens are slightly exaggerated for ease of illustration. Specifically, a spherical shape or an aspheric shape shown in the accompanying drawings is shown by instances. That is, the spherical shape or the aspheric shape is not limited to a spherical shape or an aspheric shape shown in the accompanying drawings. The accompanying drawings are merely instances and are not drawn to scale strictly.

Herein, a paraxial region refers to a region nearby an optical axis. If a lens surface is a convex surface and a position of the convex surface is not defined, the lens surface is a convex surface at least in the paraxial region. If the lens surface is a concave surface and a position of the concave surface is not defined, the lens surface is a concave surface at least in the paraxial region. A surface of each lens closest to an object is called an object-side surface of the lens. A surface of each lens closest to an imaging surface is called an image-side surface of the lens.

It should be further understood that terms “include” and/or “have”, used in the description, represent existence of a stated feature, element, and/or component but do not exclude existence or addition of one or more other features, elements, components, and/or their combinations. In addition, when embodiments of the disclosure are described, “may” is used to indicate “one or more embodiments of the disclosure”. Further, the term “exemplary” refers to an instance or illustration.

Unless otherwise defined, all terms (including technical terms and scientific terms) used herein have identical meanings generally understood by a person of ordinary skill in the art to which the disclosure pertains. It should be further understood that terms (for instance, terms defined in commonly used dictionaries) should be interpreted as having meanings that are consistent with their meanings in the context of the relevant art and will not be interpreted in an idealized or overly formalized sense unless expressly so defined herein.

It should be noted that examples in the disclosure and features in the examples may be combined with one another without conflicts. The disclosure will be described in detail below with reference to accompanying drawings and in combination with examples.

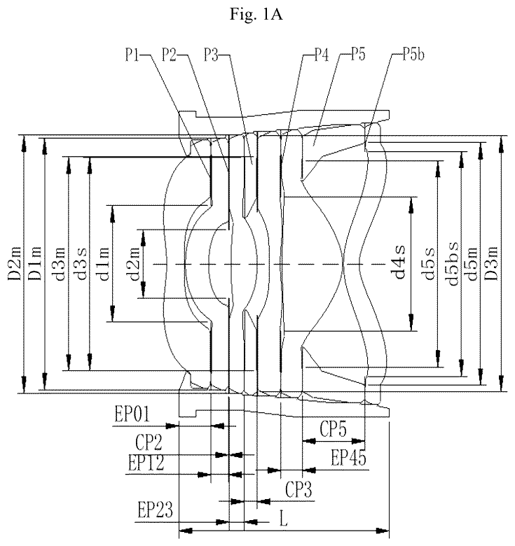

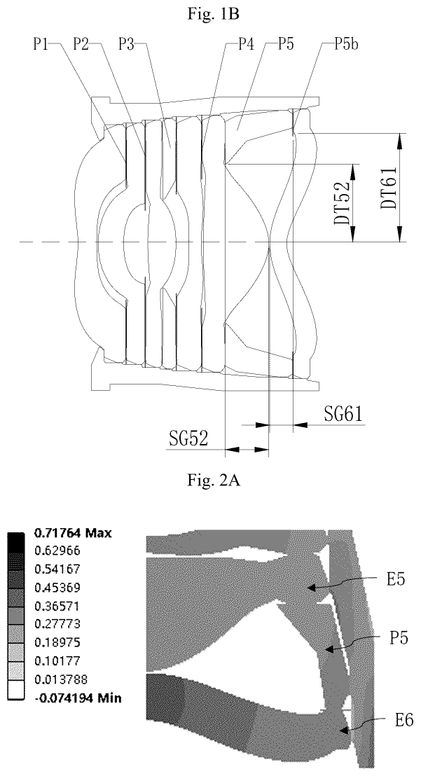

FIG. 1A is a schematic diagram of a structural arrangement diagram and some parameters of a photographing lens assembly according to an exemplary embodiment of the disclosure. With reference to FIG. 1A, d1m denotes an inner diameter of an image-side surface of a first spacer, D1m denotes an outer diameter of the image-side surface of the first spacer, d2m denotes an inner diameter of an image-side surface of a second spacer, D2m denotes an outer diameter of the image-side surface of the second spacer, d3s denotes an inner diameter of an object-side surface of a third spacer, d3m denotes an inner diameter of an image-side surface of the third spacer, D3m denotes an outer diameter of the image-side surface of the third spacer, d4s denotes an inner diameter of an object-side surface of a fourth spacer, d5s denotes an inner diameter of an object-side surface of a fifth spacer, d5m denotes an inner diameter of an image-side surface of the fifth spacer, d5bs denotes an inner diameter of an object-side surface of a fifth auxiliary spacer, EP01 denotes a spacing between an object-side end surface of a lens barrel and the first spacer along an optical axis, EP12 denotes a spacing between the first spacer and the second spacer along the optical axis, CP2 denotes a maximum thickness of the second spacer, EP23 denotes a spacing between the second spacer and the third spacer along the optical axis, CP3 denotes a maximum thickness of the third spacer, EP34 denotes a spacing between the third spacer and the fourth spacer along the optical axis, EP45 denotes a spacing between the fourth spacer and the fifth spacer along the optical axis, CP5 denotes a maximum thickness of the fifth spacer, and L denotes a maximum length of the lens barrel in a direction along the optical axis.

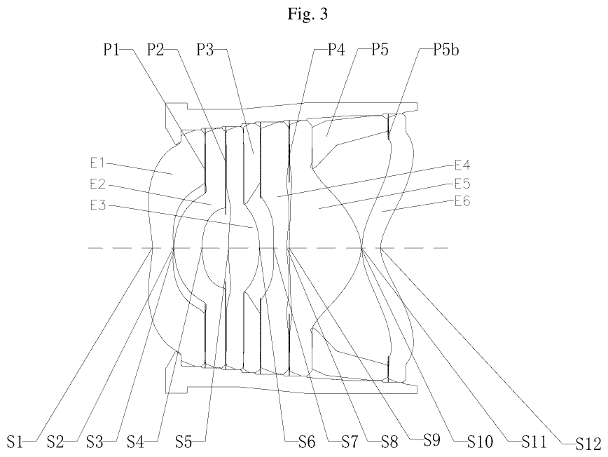

With reference to FIGS. 3 to 5, FIGS. 7 to 9, and FIGS. 11 to 13, some embodiments of the disclosure provide a photographing lens assembly. The photographing lens assembly includes a six-piece lens group. The six-piece lens group includes a first lens, a second lens, a third lens, a fourth lens, a fifth lens, and a sixth lens that are arranged in sequence from an object side to an image side along an optical axis. Air spacing is provided between any two adjacent lenses from the first lens to the sixth lens.

In an exemplary embodiment, the first lens has a negative refractive power. The second lens has a positive refractive power. The third lens has a positive refractive power. The fourth lens has a negative refractive power. The fifth lens has a positive refractive power. The sixth lens has a negative refractive power. By reasonably configuring the refractive power of each lens, the photographing lens assembly is able to satisfy a wide-angle feature.

In an exemplary embodiment, an object-side surface of the first lens is a concave surface, and an image-side surface of the first lens is a convex surface.

In an exemplary embodiment, an object-side surface of the second lens is a convex surface, and an image-side surface of the second lens is a concave surface.

In an exemplary embodiment, an object-side surface of the third lens is a convex surface, and an image-side surface of the third lens is a convex surface.

In an exemplary embodiment, an object-side surface of the fourth lens is a convex surface, and the image-side surface of the fourth lens is a concave surface.

In an exemplary embodiment, an object-side surface of the fifth lens is a convex surface or a concave surface, and the image-side surface of the fifth lens is a convex surface

In an exemplary embodiment, an object-side surface of the sixth lens is a convex surface, and an image-side surface of the sixth lens is a concave surface.

In an exemplary embodiment, a spacing distance between a non-effective diameter portion of the fifth lens and a non-effective diameter portion of the sixth lens in the direction along the optical axis is greater than a spacing distance between non-effective diameter portions of any two adjacent lenses from the first lens to the fifth lens in the direction along the optical axis.

In an exemplary embodiment, the photographing lens assembly further includes a spacer group.

The spacer group includes one or more of a first spacer, a second spacer, a third spacer, a fourth spacer, a fifth spacer, and a fifth auxiliary spacer. The first spacer is arranged on and at least partially in contact with the image-side surface of the first lens. The second spacer is arranged on and at least partially in contact with the image-side surface of the second lens. The third spacer is arranged on and at least partially in contact with the image-side surface of the third lens. The fourth spacer is arranged on and at least partially in contact with the image-side surface of the fourth lens. The fifth spacer is arranged on and at least partially in contact with the image-side surface of the fifth lens. The fifth auxiliary spacer is arranged on and at least partially in contact with the image-side surface of the fifth spacer. By reasonably using spacers, a risk of stray light is able to be effectively avoided, interference with image quality is able to be reduced, and imaging quality of the photographing lens assembly is able to be improved. Moreover, bearing-against stability of lenses is able to be ensured.

In an exemplary embodiment, the photographing lens assembly further includes a lens barrel. The six-piece lens group and the spacer group are arranged in the lens barrel. The lens barrel includes an object-side end surface, an image-side end surface, an outer ring surface and an inner ring surface. An end surface of the lens barrel closest to an object side is the object-side end surface of the lens barrel. An end surface of the lens barrel closest to an image side is the image-side end surface of the lens barrel. In a direction perpendicular to the optical axis direction, a surface of the lens barrel farthest from the optical axis is the outer ring surface. A surface of the lens barrel closest to the optical axis is the inner ring surface.

In an exemplary embodiment, the photographing lens assembly further includes a diaphragm arranged between the second lens and the third lens.

In an exemplary embodiment, an effective focal length f1 of the first lens and an effective focal length f3 of the third lens may satisfy: −2.0<f1/f3<−1.7. A total effective focal length f of the photographing lens assembly, an effective focal length f5 of the fifth lens, and an effective focal length f6 of the sixth lens may satisfy: −2.7<f/(f5+f6)<−1.2. A center thickness CT5 of the fifth lens on the optical axis and a spacing EP45 between the fourth spacer and the fifth spacer along the optical axis may satisfy: 2.2<CT5/EP45<3.4. An air spacing T45 between the fourth lens and the fifth lens on the optical axis, a center thickness CT5 of the fifth lens on the optical axis, a spacing EP45 between the fourth spacer and the fifth spacer along the optical axis, and a maximum thickness CP5 of the fifth spacer along the optical axis may satisfy: 0.5<(EP45+CP5)/(CT5+T45)<1.4.

By reasonably configuring a ratio of the total effective focal length of the photographing lens assembly to a sum of the effective focal length of the fifth lens and the effective focal length of the sixth lens, and a ratio of the effective focal length of the first lens to the effective focal length of the third lens, trends of light rays in the first lens, the third lens, the fifth lens, and the sixth lens are able to be restricted, and sensitivity of the lenses is able to be reduced. In this case, the fifth lens may be designed to have a thicker center and a thinner edge. A thickness ratio of the fifth lens satisfies “2.2<CT5/EP45<3.4”. Moreover, a spacing distance between a non-effective diameter portion of the fifth lens and a non-effective diameter portion of a sixth lens in a direction along the optical axis is greater than a spacing distance between non-effective diameter portions of any two adjacent lenses from the first lens to the fifth lens in the direction along the optical axis. The fifth lens and the sixth lens are likely to tilt, deform, etc. during assembly, thereby affecting assembly stability of the photographing lens assembly. Thus, by controlling the photographing lens assembly to satisfy “0.5<(EP45+CP5)/(CT5+T45)<1.4”, a maximum thickness of the fifth spacer is able to be restricted within a reasonable range, and an overall shape of the sixth lens is able to be indirectly controlled. Thus, the fifth lens and the sixth lens are uniformly stressed during assembly, thereby improving assembly stability of the photographing lens assembly while moldability of the fifth lens and the sixth lens is ensured.

Table 1 shows assembly states of three types of photographing lens assemblies (for instance, a photographing lens assembly 1, a photographing lens assembly 2, and a photographing lens assembly 3).

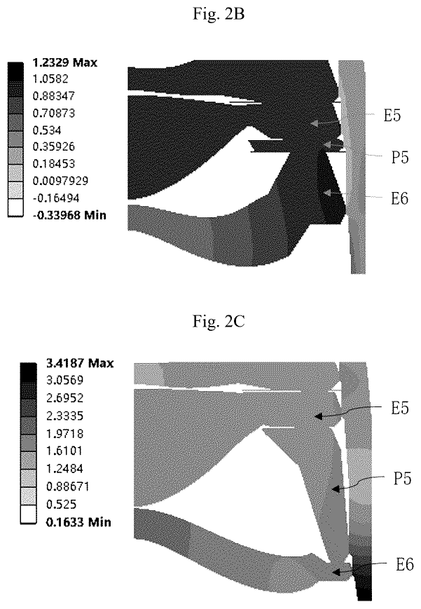

TABLE 1

| Solution | Photographing lens assembly 1 | Photographing lens assembly 2 | Photographing lens assembly 3 |
|---|---|---|---|
| | f1/f3 = −1.8 | f1/f3 = −1.8 | f1/f3 = −1.8 |
| | f/(f5 + f6) = −2.6 | f/(f5 + f6) = −1.4 | f/(f5 + f6) = −1.7 |
| | CT5/EP45 = 2.9 | CT5/EP45 = 2.3 | CT5/EP45 = 3.0 |
| | (EP45 + CP5)/(CT5 + T45) = 1.34 | (EP45 + CP5)/(CT5 + T45) = 0.2 | (EP45 + CP5)/(CT5 + T45) = 1.5 |
| Figure | FIG. 2A | FIG. 2B | FIG. 2C |
| Assembly | Stable | Unstable | Unstable |
| state | | | |

As shown in Table 1, FIG. 2A, FIG. 2B, and FIG. 2C, a schematic diagram of stress distribution of photographing lens assembly 1 in cases of f1/f3=−1.8, f/(f5+f6)=−2.6, CT5/EP45=2.9, and (EP45+CP5)/(CT5+T45)=1.34 is shown in FIG. 2A. A schematic diagram of stress distribution of photographing lens assembly 2 in cases of f1/f3=−1.8, f/(f5+f6)=−1.4, CT5/EP45=2.3, and (EP45+CP5)/(CT5+T45)=0.2 is shown in FIG. 2B. A schematic diagram of stress distribution of photographing lens assembly 3 in cases of f1/f3=−1.8, f/(f5+f6)=−1.7, CT5/EP45=3.0, and (EP45+CP5)/(CT5+T45)=1.5 is shown in FIG. 2C.

In terms of FIG. 2B, in a case of (EP45+CP5)/(CT5+T45)=0.2, a ratio of an edge thickness to a center thickness of the sixth lens is large, and curvature of a transition portion of an non-effective diameter portion and an effective diameter portion of the sixth lens is large, such that the sixth lens is difficult to mold. Moreover, obvious stress concentration exits at a position of the sixth lens for bearing against the fifth spacer, such that the sixth lens is likely to tilt, deform, etc. during assembly, and assembly stability of the photographing lens assembly is poor. In terms of FIG. 2C, in a case of (EP45+CP5)/(CT5+T45)=1.5, an edge thickness of the sixth lens is small, such that the sixth lens is difficult to mold. Moreover, obvious stress concentration exists at a bearing-against position in the lens barrel corresponding to the sixth lens and the fifth spacer, such that the sixth lens is likely to tilt, deform, etc. during assembly, and assembly stability of the photographing lens assembly is poor. In terms of FIG. 2A, in a case of (EP45+CP5)/(CT5+T45)=1.34, overall stress of the sixth lens is uniform, and a thickness ratio is conducive to molding. Thus, stress concentration of the sixth lens is reduced, and assembly stability of the photographing lens assembly is improved.

It is able to be seen that in a case that the photographing lens assembly satisfies “−2.7<f/(f5+f6)<−1.2, −2.0<f1/f3<−1.7, and 2.2<CT5/EP45<3.4”, by further adjusting the photographing lens assembly to satisfy 0.5<(EP45+CP5)/(CT5+T45)<1.4, a risk that the sixth lens tilts and deforms during assembly is able to be effectively reduced, and assembly stability of the photographing lens assembly is able to be improved.

In an exemplary embodiment, a spacing EP01 between the object-side end surface of the lens barrel and the first spacer along the optical axis, a center thickness CT1 of the first lens on the optical axis, and an air spacing T12 between the first lens and the second lens on the optical axis satisfy: 1.0<EP01/(CT1+T12)<2.7. By controlling the above conditional expression, the spacing between the object-side end surface of the lens barrel and the first spacer along the optical axis is able to be restricted within a reasonable range. Thus, a thickness along the axis of an object-side end of the lens barrel is able to be limited, molding and filling are able to be facilitated, and risks of a sharp corner and stray light of a light transmission hole are able to be reduced. Moreover, an edge thickness of a non-effective diameter portion of the first lens is able to be limited, to satisfy a molding requirement.

In an exemplary embodiment, an effective focal length f1 of the first lens and a curvature radius R2 of the image-side surface of the first lens satisfy: 0.8<f1/R2<1.8. An inner diameter d1m of the image-side surface of the first spacer and an outer diameter D1m of the image-side surface of the first spacer satisfy: 1.8<D1m/d1m<2.6. By controlling a ratio of the effective focal length of the first lens to the curvature radius of the image-side surface of the first lens, an overall shape of the first lens is able to be restricted such that the first lens is able to be favorably processed and molded. Moreover, by limiting a ratio of the outer diameter to the inner diameter of the image-side surface of the first spacer, redundant light rays transmitted through an edge of the first lens are able to be blocked by the first spacer, and image quality of the photographing lens assembly is able to be improved.

In an exemplary embodiment, a combined focal length f345 of the third lens, the fourth lens, and the fifth lens, an inner diameter d2m of the image-side surface of the second spacer, and an inner diameter d5s of the object-side surface of the fifth spacer satisfy: 1.1<(d5s−d2m)/f345<1.8. By controlling the above conditional expression, the combined focal length of the third lens, the fourth lens and the fifth lens is able to be restricted within a range such that trends of light rays in these three lenses are able to be effectively controlled. Moreover, the optical total length of the photographing lens assembly is able to be coordinated such that sufficient space is able to be reserved for designs of the first lens, the second lens, and the sixth lens. In addition, by limiting the inner diameter of the image-side surface of the second spacer and the inner diameter of the object-side surface of the fifth spacer, it can be ensured that non-imaging light rays are able to be blocked by the second spacer and the fifth spacer, to reduce a risk of stray light of the photographing lens assembly.

In an exemplary embodiment, a center thickness CT2 of the second lens on the optical axis, an air spacing T23 between the second lens and the third lens on the optical axis, a spacing EP12 between the first spacer and the second spacer along the optical axis, and a maximum thickness CP2 of the second spacer along the optical axis satisfy: 1.7<(CT2+T23)/(EP12+CP2)<3.3. By controlling the above conditional expression, an edge thickness and a center thickness of the second lens and the air spacing between the second lens and the third lens are able to be restricted within reasonable ranges. Thus, uniformity of the entire surface type structure of the second lens is able to be effectively limited, and processing and injection molding by using a lens mold are able to be facilitated.

In an exemplary embodiment, an air spacing T23 between the second lens and the third lens on the optical axis, a center thickness CT3 of the third lens on the optical axis, an air spacing T34 between the third lens and the fourth lens on the optical axis, and a spacing EP23 between the second spacer and the third spacer along the optical axis satisfy: 1.0<(EP23+CT3)/(T23+T34)<2.3. By controlling the above conditional expression, an edge thickness and a center thickness of the third lens are able to be restricted within a reasonable range. Thus, uniformity of the entire structure of the third lens is able to be effectively limited, and an acrylonitrile-styrene resin molding risk is able to be reduced. Moreover, by limiting the air spacing between the second lens and the third lens and the air spacing between the third lens and the fourth lens, distribution uniformity of light rays is able to be adjusted, and a peak value of the photographing lens assembly is able to be improved.

In an exemplary embodiment, an inner diameter d2m of the image-side surface of the second spacer, an outer diameter D2m of the image-side surface of the second spacer, an inner diameter d3m of the image-side surface of the third spacer, and an outer diameter D3m of the image-side surface of the third spacer satisfy: 1.4<(D2m−d2m)/(D3m−d3m)<5.3. By controlling the above conditional expression, the inner diameter and the outer diameter of the image-side surface of the second spacer are able to be restricted within reasonable ranges. Thus, it is ensured that stray light reflected inside the second lens and stray light at the edge of the second lens are able to be blocked by the second spacer and therefore are able to be prevented from entering the third lens. Moreover, by limiting the inner diameter and the outer diameter of the image-side surface of the third spacer, a position and size of the third spacer bearing against the fourth lens are able to be determined. Thus, assembly stability of the photographing lens assembly is able to be improved, and an assembly yield of the photographing lens assembly is able to be improved.

In an exemplary embodiment, an air spacing T34 between the third lens and the fourth lens on the optical axis, a center thickness CT4 of the fourth lens on the optical axis, and a maximum thickness CP3 of the third spacer along the optical axis satisfy: 0.4<CP3/(T34+CT4)<0.8. By controlling a relationship among the maximum thickness of the third spacer, the air spacing between the third lens and the fourth lens on the optical axis, and the center thickness of the fourth lens on the optical axis, uniformity of the entire structure of the fourth lens is able to be effectively limited. Thus, the fourth lens is able to be favorably processed and molded, and stray light is able to be reduced.

In an exemplary embodiment, a center thickness CT3 of the third lens on the optical axis, an outer diameter D3m of the image-side surface of the third spacer, and a spacing EP34 between the third spacer and the fourth spacer along the optical axis satisfy: 3.0<D3m/(EP34+CT3)<4.5. By controlling the above conditional expression, an edge thickness of the fourth lens is able to be restricted. A thickness ratio of the fourth lens is able to be restricted within a reasonable range such that a molding risk is able to be reduced. Moreover, by limiting the center thickness of the third lens and the outer diameter of the image-side surface of the third spacer, a bearing-against size of the third spacer and the fourth lens are able to be restricted while moldability of the third lens is ensured. Assembly stability of the photographing lens assembly is able to be improved.

In an exemplary embodiment, an effective focal length f3 of the third lens, an effective focal length f4 of the fourth lens, an inner diameter d3s of the object-side surface of the third spacer, and an inner diameter d4s of the object-side surface of the fourth spacer satisfy: −2.0<f4/f3+d4s/d3s<−0.5. By controlling the above conditional expression, the effective focal length of the third lens and the effective focal length of the fourth lens are able to be limited, and trends of light rays in the third lens and the fourth lens are able to be effectively restricted. Moreover, by limiting the inner diameter of the object-side surface of the third spacer and the inner diameter of the object-side surface of the fourth spacer, edge light rays of the third lens and the fourth lens are able to be controlled to prevent aspheric edge ineffective light and reflected light from entering a rear lens. Thus, an amount and intensity of overall stray light of the photographing lens assembly are able to be reduced, and imaging quality of the photographing lens assembly is able to be improved.

In an exemplary embodiment, the effective focal length f5 of the fifth lens, the effective focal length f6 of the sixth lens, and an inner diameter d5bs of the object-side surface of the fifth auxiliary spacer satisfy: −0.5<(f5+f6)/d5bs<0. By controlling the above conditional expression, the effective focal length of the fifth lens and the effective focal length of the sixth lens are able to be limited within reasonable ranges such that an overall shape of the fifth lens and an overall shape of the sixth lens are able to be effectively restricted. Moreover, by limiting the inner diameter of the object-side surface of the fifth auxiliary spacer, reflected light rays and edge ineffective light rays of the fifth spacer are able to be blocked by the fifth auxiliary spacer such that a risk of stray light is able to be reduced.

In an exemplary embodiment, a maximum length L of the lens barrel in the direction along the optical axis, a total effective focal length f of the photographing lens assembly, and an f-number FNO of the photographing lens assembly satisfy: 3.9<L/f×FNO<4.8. By controlling the above conditional expression, the total effective focal length and the F-number of the photographing lens assembly are able to be restricted within reasonable ranges, and reasonable distribution of each lens in a total length of the lens barrel is able to be limited.

In an exemplary embodiment, a maximum effective semi-diameter DT52 of the image-side surface of the fifth lens, a maximum effective semi-diameter DT61 of the object-side surface of the sixth lens, an inner diameter d5s of the object-side surface of the fifth spacer, and an inner diameter d5m of the image-side surface of the fifth spacer satisfy: 5.0<d5s/DT52+d5m/DT61<6.0. By controlling the above conditional expression, the maximum effective semi-diameter of the image-side surface of the fifth lens and the maximum effective semi-diameter of the object-side surface of the sixth lens are able to be restricted such that smoothness of edge light rays between the fifth lens and the sixth lens are able to be effectively controlled. Moreover, by limiting the inner diameter of the object-side surface and the inner diameter of the image-side surface of the fifth spacer, a misalignment amount of non-effective diameter positions of two lenses and bearing-against misalignment amounts of the fifth spacer and a front lens and a rear lens are able to be effectively restricted, and assembly stability of the photographing lens assembly is able to be improved.

In an exemplary embodiment, a distance SG52 from an intersection point between the image-side surface of the fifth lens and the optical axis to the object-side surface of the fifth spacer on the optical axis, a distance SG61 from an intersection point between the object-side surface of the sixth lens and the optical axis to the image-side surface of the fifth spacer on the optical axis, and a center thickness CT5 of the fifth lens on the optical axis satisfy: 0.6<(|SG52|+|SG61|)/CT5<1.1. By controlling the above conditional expression, a surface type trend of the image-side surface of the fifth lens and a surface type trend of the object-side surface of the sixth lens are able to be restricted such that a trend of light rays at a rear end of the photographing lens assembly is able to be controlled. Moreover, by limiting the center thickness of the fifth lens, a molding difficulty of the fifth lens is able to be reduced, and the fifth lens is able to be favorably molded.

In an exemplary embodiment, an f-number FNO of the photographing lens assembly satisfies: 1.3<FNO<1.5. By reasonably configuring the F-number of the photographing lens assembly, a large aperture of the photographing lens assembly is able to be achieved.

In an exemplary embodiment, a semi-maximum field of view Semi-FOV of the photographing lens assembly satisfies: 50°<Semi-FOV<65°. By reasonably configuring a semi-maximum field of view of the photographing lens assembly, a large field of view of the photographing lens assembly is able to be achieved.

Six lenses and at least one spacer are configured for the photographing lens assembly according to the above embodiments of the disclosure. By reasonably distributing parameters of each lens, the lens barrel, and each spacer, the photographing lens assembly is able to be favorably processed and molded. Moreover, a risk of stray light of the photographing lens assembly is able to be reduced, and assembly stability, an assembly yield, and imaging quality of the photographing lens assembly are able to be improved.

In embodiments of the disclosure, at least one of surfaces of each of the first lens to the sixth lens is an aspheric surface. The aspheric lens has a feature that curvature is continuously changed from a center to a periphery of the lens. Different from a spherical lens having constant curvature from a center to a periphery of the lens, the aspheric lens has a better curvature radius and is able to reduce distortion and astigmatism. After the aspheric lens is used, aberration occurring during imaging is able to be eliminated as much as possible such that imaging quality is able to be improved. In an embodiment, the object-side surface and the image-side surface of each of the first lens to the sixth lens are aspheric surfaces.

In another embodiment of the disclosure, a photographing lens assembly is provided. The paragraphing lens includes a lens barrel, and a six-piece lens group and a spacer group that are arranged in the lens barrel. The six-piece lens group includes a first lens having a negative refractive power, a second lens having a positive refractive power, a third lens having a positive refractive power, a fourth lens having a negative refractive power, a fifth lens having a positive refractive power, and a sixth lens having a negative refractive power that are arranged in sequence from an object side to an image side along an optical axis. The spacer group includes a fifth spacer arranged on and in contact with an image-side surface of the fifth lens.

In an exemplary embodiment, a maximum effective semi-diameter DT52 of an image-side surface of the fifth lens, a maximum effective semi-diameter DT61 of an object-side surface of the sixth lens, an inner diameter d5s of an object-side surface of the fifth spacer, and an inner diameter d5m of an image-side surface of the fifth spacer satisfy: 5.0<d5s/DT52+d5m/DT61<6.0. By controlling the above conditional expression, the maximum effective semi-diameter of the image-side surface of the fifth lens and the maximum effective semi-diameter of the object-side surface of the sixth lens are able to be restricted such that smoothness of edge light rays between the fifth lens and the sixth lens is able to be effectively controlled. Moreover, by limiting the inner diameter of the object-side surface and the inner diameter of the image-side surface of the fifth spacer, a misalignment amount of non-effective diameter positions of two lenses and bearing-against misalignment amounts of the fifth spacer and a front lens and a rear lens are able to be effectively restricted, and assembly stability of the photographing lens assembly is able to be improved.

In yet another embodiment of the disclosure provides a photographing lens assembly. The paragraphing lens includes a lens barrel, and a six-piece lens group and a spacer group that are arranged in the lens barrel. The six-piece lens group includes a first lens having a negative refractive power, a second lens having a positive refractive power, a third lens having a positive refractive power, a fourth lens having a negative refractive power, a fifth lens having a positive refractive power, and a sixth lens having a negative refractive power that are arranged in sequence from an object side to an image side along an optical axis. The spacer group includes a second spacer arranged on and in contact with an image-side surface of the second lens and a fifth spacer arranged on and in contact with an image-side surface of the fifth lens.

A combined focal length f345 of the third lens, the fourth lens, and the fifth lens, an inner diameter d2m of an image-side surface of the second spacer, and an inner diameter d5s of an object-side surface of the fifth spacer satisfy: 1.1<(d5s−d2m)/f345<1.8. By controlling the above conditional expression, the combined focal length of the third lens, the fourth lens and the fifth lens is able to be restricted within a range such that trends of light rays in these three lenses are able to be effectively controlled. Moreover, the optical total length of the photographing lens assembly is able to be coordinated such that sufficient space is able to be reserved for designs of the first lens, the second lens, and the sixth lens. In addition, by limiting the inner diameter of the image-side surface of the second spacer and the inner diameter of the object-side surface of the fifth spacer, it can be ensured that non-imaging light rays are able to be blocked by the second spacer and the fifth spacer, to reduce a risk of stray light of the photographing lens assembly.

It should be understood by a person skilled in the art that without departing from the technical solution claimed in the disclosure, a number of lenses and a number of spacers that constitute the photographing lens assembly may be changed such that various results and advantages described in the description are able to be obtained.

Particular examples of the photographing lens assembly that are able to be suitable for the above embodiments will be further described below with reference to accompanying drawings.

### Example 1

A photographing lens assembly according to Example 1 of the disclosure will be described below with reference to FIG. 3.

As shown in FIG. 3, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b. By the spacers, redundant light rays during imaging are able to be prevented from entering a next lens. Moreover, the lenses are able to better bear against the lens barrel, such that structural stability of the photographing lens assembly is enhanced.

The first lens E1 has a negative refractive power, an object-side surface S1 of the first lens is a concave surface, and an image-side surface S2 of the first lens is a convex surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. In an instance, an optical filter is arranged between the sixth lens E6 and an imaging surface S15 (not shown). The optical filter has an object-side surface S13 (not shown) and an image-side surface S14 (not shown). Light rays from an object pass through surfaces S1 to S14 in sequence to be finally imaged on the imaging surface S15.

Table 2 shows a basic parameter table of the photographing lens assembly in Example 1. Units of a curvature radius, a thickness/distance, and a focal length are millimeter (mm).

TABLE 2

| | | | | Material | | | |
|---|---|---|---|---|---|---|---|
| Surface | Surface | Curvature | Thickness/ | Refractive | Abbe | Focal | Cone |
| number | type | radius | distance | index | number | length | coefficient |
| OBJ | Spherical | Infinity | 2000.0000 | | | | |
| S1 | Aspheric | −2.6948 | 0.6825 | 1.535 | 55.8 | −7.84 | −10.29 |
| S2 | Aspheric | −8.1416 | 0.0387 | | | | −92.63 |
| S3 | Aspheric | 2.7334 | 0.9052 | 1.671 | 19.2 | 139.95 | 1.26 |
| S4 | Aspheric | 2.4372 | 0.7777 | | | | 2.58 |
| STO | Spherical | Infinity | 0.0874 | | | | |
| S5 | Aspheric | 8.6849 | 1.0083 | 1.544 | 56.1 | 4.18 | 4.51 |
| S6 | Aspheric | −2.9773 | 0.4595 | | | | 1.44 |
| S7 | Aspheric | 11.3022 | 0.4380 | 1.671 | 19.2 | −7.46 | −85.56 |
| S8 | Aspheric | 3.4432 | 0.0764 | | | | −14.15 |
| S9 | Aspheric | 29.1420 | 2.3448 | 1.544 | 56.1 | 2.04 | 58.70 |
| S10 | Aspheric | −1.1276 | 0.0300 | | | | −1.52 |
| S11 | Aspheric | 1.8763 | 0.6082 | 1.661 | 20.4 | −3.61 | −4.71 |
| S12 | Aspheric | 0.9188 | 1.2601 | | | | −3.75 |
| S13 | Spherical | Infinity | 0.2100 | 1.517 | 64.2 | | |
| S14 | Spherical | Infinity | 0.4000 | | | | |
| S15 | Spherical | Infinity | | | | | |

In the example, a value of a total effective focal length f of the photographing lens assembly is 2.63 mm. A value of an f-number FNO of the photographing lens assembly is 1.45. A value of a semi-maximum field of view Semi-FOV of the photographing lens assembly is 54.84°.

In the example, the object-side surface and the image-side surface of any one of the first lens E1 to the sixth lens E6 are aspheric surfaces. Surface type X of each aspheric lens may be defined by using a formula including but not limited to an aspheric formula as follows:

$$x = \frac{{ch}^{2}}{1 + \sqrt{1 - ( k + 1 ) {c}^{2} {h}^{2}}} + \sum {Aih}^{i} . \qquad ( 1 )$$

Specifically, X is a vector height of a distance to a vertex of the aspheric surface when the aspheric surface is located at a position having height h in a direction along the optical axis; c is paraxial curvature of the aspheric surface, and c=1/R (that is, paraxial curvature c is a reciprocal of a curvature radius R in Table 2 above); k is a cone coefficient; and Ai is a correction coefficient of an i-th order of the aspheric surface. Table 3 gives coefficients A₄, A₆, A₈, A₁₀, A₁₂, A₁₄, A₁₆, A₁₈, A₂₀, A₂₂, A₂₄, A₂₆, A₂₈ and A₃₀ of high-order terms that may be used for aspheric surfaces S1 to S12 in Example 1.

TABLE 3

| Surface | | | | | | | |
|---|---|---|---|---|---|---|---|
| number | A4 | A6 | A8 | A10 | A12 | A14 | A16 |
| S1 | 7.51E−02 | −4.85E−02 | 2.99E−02 | −1.57E−02 | 6.68E−03 | −2.23E−03 | 5.67E−04 |
| S2 | 3.49E−01 | −6.89E−01 | 1.15E+00 | −1.37E+00 | 1.08E+00 | −4.79E−01 | 1.56E−03 |
| S3 | 1.86E−01 | −4.72E−01 | 7.29E−01 | −5.40E−01 | −3.17E−01 | 1.41E+00 | −1.95E+00 |
| S4 | 1.77E−02 | −1.98E−01 | 1.39E+00 | −4.53E+00 | 4.47E+00 | 2.20E+01 | −1.07E+02 |
| S5 | 3.57E−02 | −5.40E−01 | 4.47E+00 | −2.38E+01 | 8.60E+01 | −2.19E+02 | 4.03E+02 |
| S6 | −3.32E−02 | −1.50E−01 | 1.18E+00 | −5.04E+00 | 1.43E+01 | −2.83E+01 | 4.02E+01 |
| S7 | −1.64E−01 | 1.68E−01 | −5.30E−01 | 1.54E+00 | −3.10E+00 | 4.36E+00 | −4.39E+00 |
| S8 | −5.44E−02 | 2.74E−02 | −9.59E−02 | 2.01E−01 | −2.55E−01 | 2.21E−01 | −1.36E−01 |
| S9 | 5.25E−02 | −4.35E−02 | −4.84E−02 | 1.27E−01 | −1.39E−01 | 1.02E−01 | −5.61E−02 |
| S10 | 1.43E−01 | −2.10E−01 | 2.32E−01 | −1.97E−01 | 1.24E−01 | −5.74E−02 | 1.94E−02 |
| S11 | 1.80E−02 | −2.36E−02 | 3.30E−02 | −3.10E−02 | 1.85E−02 | −7.38E−03 | 2.05E−03 |
| S12 | −1.62E−02 | 2.60E−02 | −1.90E−02 | 5.10E−03 | 1.12E−03 | −1.39E−03 | 5.35E−04 |
| Surface | | | | | | | |
| number | A18 | A20 | A22 | A24 | A26 | A28 | A30 |
| S1 | −1.09E−04 | 1.56E−05 | −1.62E−06 | 1.19E−07 | −5.85E−09 | 1.72E−10 | −2.28E−12 |
| S2 | 1.55E−01 | −1.14E−01 | 4.56E−02 | −1.15E−02 | 1.83E−03 | −1.67E−04 | 6.76E−06 |
| S3 | 1.66E+00 | −9.72E−01 | 3.97E−01 | −1.12E−01 | 2.08E−02 | −2.29E−03 | 1.13E−04 |
| S4 | 2.38E+02 | −3.32E+02 | 3.09E+02 | −1.92E+02 | 7.66E+01 | −1.79E+01 | 1.85E+00 |
| S5 | −5.38E+02 | 5.23E+02 | −3.66E+02 | 1.80E+02 | −5.86E+01 | 1.14E+01 | −1.00E+00 |
| S6 | −4.13E+01 | 3.08E+01 | −1.64E+01 | 6.11E+00 | −1.51E+00 | 2.21E−01 | −1.46E−02 |
| S7 | 3.20E+00 | −1.70E+00 | 6.48E−01 | −1.72E−01 | 3.04E−02 | −3.17E−03 | 1.48E−04 |
| S8 | 6.06E−02 | −1.94E−02 | 4.40E−03 | −6.88E−04 | 7.00E−05 | −4.13E−06 | 1.06E−07 |
| S9 | 2.36E−02 | −7.53E−03 | 1.78E−03 | −3.00E−04 | 3.41E−05 | −2.33E−06 | 7.19E−08 |
| S10 | −4.78E−03 | 8.42E−04 | −1.03E−04 | 8.16E−06 | −3.69E−07 | 6.01E−09 | 8.53E−11 |
| S11 | −4.05E−04 | 5.71E−05 | −5.71E−06 | 3.95E−07 | −1.80E−08 | 4.82E−10 | −5.79E−12 |
| S12 | −1.22E−04 | 1.82E−05 | −1.85E−06 | 1.26E−07 | −5.50E−09 | 1.40E−10 | −1.58E−12 |

### Example 2

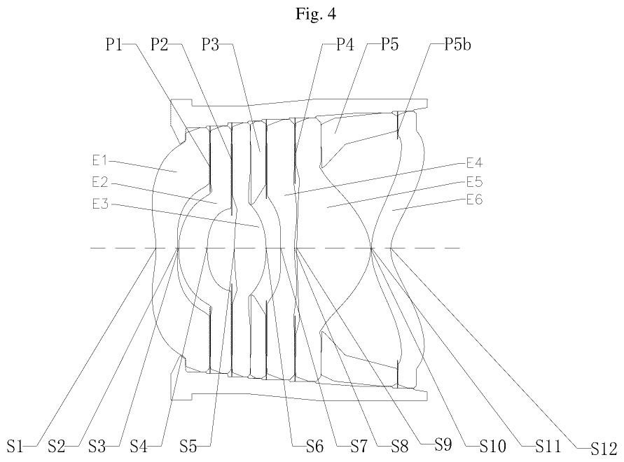

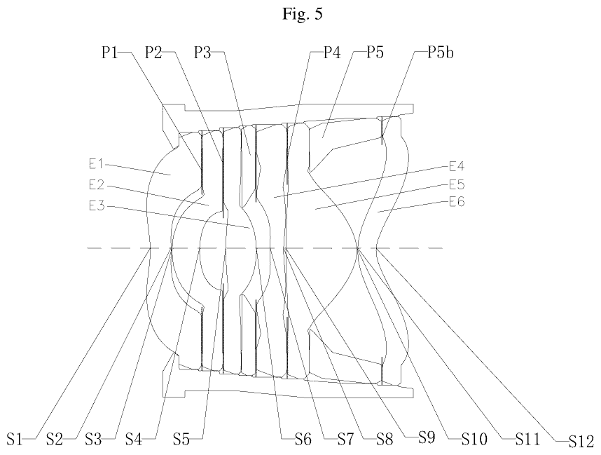

A photographing lens assembly according to Example 2 of the disclosure will be described below with reference to FIG. 4.

As shown in FIG. 4, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 1. That is, a basic parameter table of the photographing lens assembly in the example is the same as Table 2. An aspheric coefficient table is the same as Table 3. The differences between the example and Example 1 lie in that at least some elements of the lens barrel, the first spacer P1, the second spacer P2, the third spacer P3, the fourth spacer P4, the fifth spacer P5, and the fifth auxiliary spacer P5b have different structure sizes.

### Example 3

A photographing lens assembly according to Example 3 of the disclosure will be described below with reference to FIG. 5.

As shown in FIG. 5, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 1. That is, a basic parameter table of the photographing lens assembly in the example is the same as Table 2. An aspheric coefficient table is the same as Table 3. The differences between the example and Example 1 lie in that at least some elements of the lens barrel, the first spacer P1, the second spacer P2, the third spacer P3, the fourth spacer P4, the fifth spacer P5, and the fifth auxiliary spacer P5b have different structure sizes.

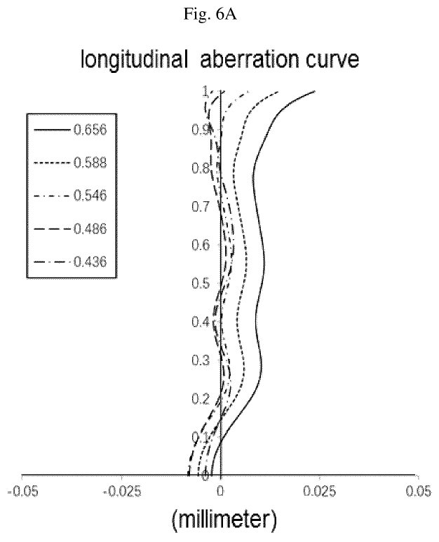

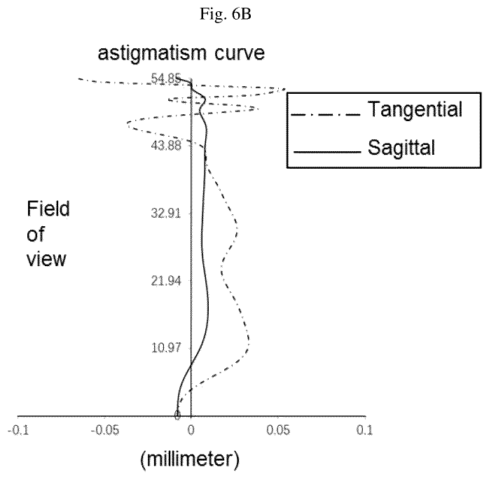

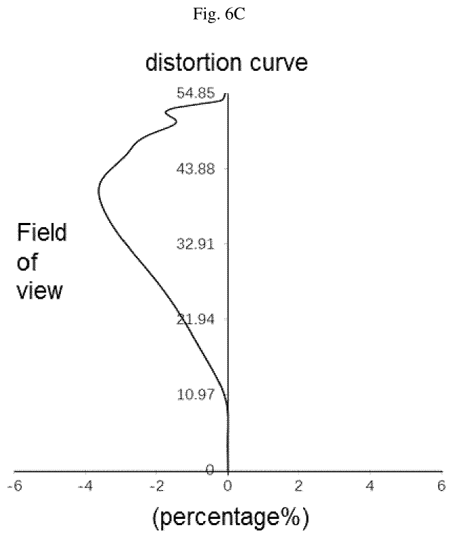

FIG. 6A shows longitudinal chromatic aberration curves of the photographing lens assembly in Examples 1, 2 and 3, which denote convergence focal point deviations after light having different wavelengths passes through the photographing lens assembly. FIG. 6B shows astigmatism curves of the photographing lens assembly in Examples 1, 2 and 3, which denote tangential image surface curvature and sagittal image surface curvature corresponding to different fields of view. FIG. 6C shows a distortion curve of the photographing lens assembly in Examples 1, 2 and 3, which denote distortion magnitude values corresponding to different fields of view. It can be seen from FIGS. 6A to 6C that excellent imaging quality is able to be achieved by the photographing lens assembly provided in Examples 1, 2, and 3.

### Example 4

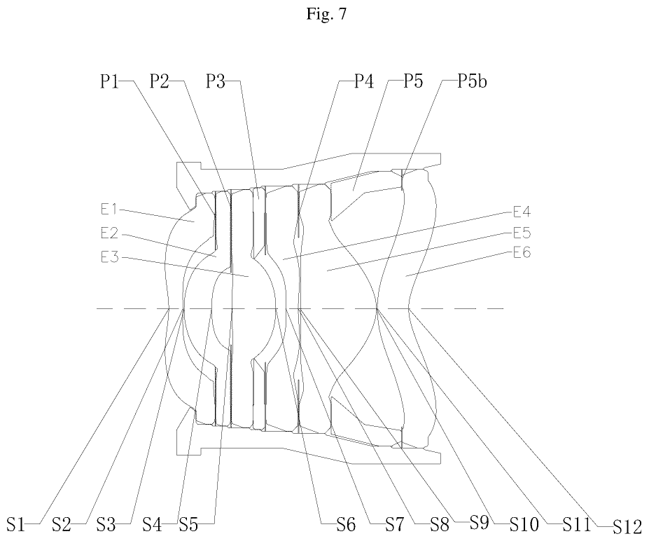

A photographing lens assembly according to Example 4 of the disclosure will be described below with reference to FIG. 7.

As shown in FIG. 7, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b. By the spacers, redundant light rays during imaging are able to be prevented from entering a next lens. Moreover, the lenses are able to better bear against the lens barrel, such that structural stability of the photographing lens assembly is enhanced.

The first lens E1 has a negative refractive power, an object-side surface S1 of the first lens is a concave surface, and an image-side surface S2 of the first lens is a convex surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a positive refractive power, an object-side surface S9 of the fifth lens is a concave surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. In an instance, an optical filter is arranged between the sixth lens E6 and an imaging surface S15 (not shown). The optical filter has an object-side surface S13 (not shown) and an image-side surface S14 (not shown). Light rays from an object pass through surfaces S1 to S14 in sequence to be finally imaged on the imaging surface S15.

Table 4 shows a basic parameter table of the photographing lens assembly in Example 4. Units of a curvature radius, a thickness/distance, and a focal length are millimeter (mm).

TABLE 4

| | | | | Material | | | |
|---|---|---|---|---|---|---|---|
| Surface | Surface | Curvature | Thickness/ | Refractive | Abbe | Focal | Cone |
| number | type | Radius | distance | index | number | length | coefficient |
| OBJ | Spherical | Infinity | 2000.0000 | | | | |
| S1 | Aspheric | −2.1556 | 0.4058 | 1.535 | 55.8 | −7.78 | −9.00 |
| S2 | Aspheric | −4.7424 | 0.0345 | | | | −86.74 |
| S3 | Aspheric | 2.7240 | 0.7907 | 1.671 | 19.2 | 21.82 | 0.91 |
| S4 | Aspheric | 2.9452 | 0.5633 | | | | 4.25 |
| STO | Spherical | Infinity | 0.0307 | | | | |
| S5 | Aspheric | 24.3387 | 1.2602 | 1.544 | 56.1 | 4.28 | 97.08 |
| S6 | Aspheric | −2.5372 | 0.2952 | | | | 1.04 |
| S7 | Aspheric | 20.5406 | 0.3502 | 1.671 | 19.2 | −5.98 | −92.59 |
| S8 | Aspheric | 3.3698 | 0.0660 | | | | −34.82 |
| S9 | Aspheric | −45.4569 | 2.1900 | 1.544 | 56.1 | 2.12 | −96.61 |
| S10 | Aspheric | −1.1494 | 0.0280 | | | | −1.47 |
| S11 | Aspheric | 3.0648 | 0.9029 | 1.671 | 19.2 | −4.08 | −4.03 |
| S12 | Aspheric | 1.2827 | 1.2390 | | | | −5.07 |
| S13 | Spherical | Infinity | 0.2100 | 1.517 | 64.2 | | |
| S14 | Spherical | Infinity | 0.4000 | | | | |
| S15 | Spherical | Infinity | | | | | |

In the example, a value of a total effective focal length f of the photographing lens assembly is 2.71 mm. A value of an f-number FNO of the photographing lens assembly is 1.44. A value of a semi-maximum field of view Semi-FOV of the photographing lens assembly is 54.64°.

In the example, the object-side surface and the image-side surface of any one of the first lens E1 to the sixth lens E6 are aspheric surfaces. Table 5 gives coefficients A₄, A₆, A₈, A₁₀, A₁₂, A₁₄, A₁₆, A₁₈, A₂₀, A₂₂, A₂₄, A₂₆, A₂₈ and A₃₀ of high-order terms that may be used for aspheric surfaces S1 to S12 in Example 4.

TABLE 5

| Surface | | | | | | | |
|---|---|---|---|---|---|---|---|
| number | A4 | A6 | A8 | A10 | A12 | A14 | A16 |
| S1 | 1.57E−01 | −1.72E−01 | 1.67E−01 | −1.29E−01 | 7.83E−02 | −3.64E−02 | 1.29E−02 |
| S2 | 4.18E−01 | −1.06E+00 | 2.32E+00 | −3.87E+00 | 4.79E+00 | −4.38E+00 | 2.95E+00 |
| S3 | 2.10E−01 | −6.46E−01 | 1.14E+00 | −4.95E−01 | −2.85E+00 | 8.46E+00 | −1.29E+01 |
| S4 | 2.58E−02 | −7.63E−02 | 1.15E+00 | −5.04E+00 | 6.16E+00 | 4.23E+01 | −2.51E+02 |
| S5 | 3.99E−02 | −7.12E−01 | 7.37E+00 | −4.64E+01 | 1.93E+02 | −5.51E+02 | 1.12E+03 |
| S6 | −5.28E−02 | −1.31E−01 | 1.20E+00 | −5.01E+00 | 1.39E+01 | −2.74E+01 | 3.87E+01 |
| S7 | −2.93E−01 | 3.89E−01 | −1.11E+00 | 3.25E+00 | −6.78E+00 | 9.82E+00 | −1.02E+01 |
| S8 | −1.15E−01 | 2.46E−01 | −7.21E−01 | 1.37E+00 | −1.73E+00 | 1.58E+00 | −1.08E+00 |
| S9 | 1.35E−02 | 2.45E−01 | −9.12E−01 | 1.60E+00 | −1.76E+00 | 1.34E+00 | −7.29E−01 |
| S10 | 1.65E−01 | −2.50E−01 | 2.48E−01 | −1.60E−01 | 5.57E−02 | 2.61E−03 | −1.42E−02 |
| S11 | 7.93E−02 | −1.31E−01 | 1.34E−01 | −9.49E−02 | 4.72E−02 | −1.69E−02 | 4.37E−03 |
| S12 | 1.37E−03 | −2.50E−03 | 2.48E−03 | −4.03E−03 | 3.16E−03 | −1.44E−03 | 4.29E−04 |
| Surface | | | | | | | |
| number | A18 | A20 | A22 | A24 | A26 | A28 | A30 |
| S1 | −3.44E−03 | 6.84E−04 | −9.97E−05 | 1.03E−05 | −7.11E−07 | 2.95E−08 | −5.54E−10 |
| S2 | −1.47E+00 | 5.38E−01 | −1.42E−01 | 2.63E−02 | −3.22E−03 | 2.34E−04 | −7.56E−06 |
| S3 | 1.28E+01 | −8.77E+00 | 4.22E+00 | −1.40E+00 | 3.07E−01 | −3.97E−02 | 2.31E−03 |
| S4 | 6.84E+02 | −1.15E+03 | 1.29E+03 | −9.55E+02 | 4.53E+02 | −1.25E+02 | 1.52E+01 |
| S5 | −1.64E+03 | 1.74E+03 | −1.32E+03 | 6.99E+02 | −2.45E+02 | 5.08E+01 | −4.75E+00 |
| S6 | −3.98E+01 | 2.97E+01 | −1.58E+01 | 5.90E+00 | −1.45E+00 | 2.13E−01 | −1.40E−02 |
| S7 | 7.60E+00 | −4.13E+00 | 1.61E+00 | −4.38E−01 | 7.90E−02 | −8.50E−03 | 4.13E−04 |
| S8 | 5.64E−01 | −2.24E−01 | 6.62E−02 | −1.41E−02 | 2.02E−03 | −1.75E−04 | 6.86E−06 |
| S9 | 2.91E−01 | −8.54E−02 | 1.82E−02 | −2.75E−03 | 2.79E−04 | −1.71E−05 | 4.77E−07 |
| S10 | 8.24E−03 | −2.74E−03 | 5.99E−04 | −8.78E−05 | 8.33E−06 | −4.64E−07 | 1.15E−08 |
| S11 | −8.31E−04 | 1.15E−04 | −1.16E−05 | 8.11E−07 | −3.78E−08 | 1.05E−09 | −1.31E−11 |
| S12 | −8.77E−05 | 1.25E−05 | −1.25E−06 | 8.54E−08 | −3.80E−09 | 9.92E−11 | −1.15E−12 |

### Example 5

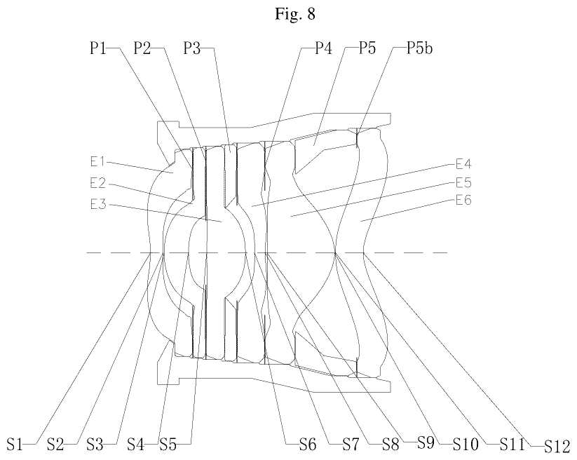

A photographing lens assembly according to Example 5 of the disclosure will be described below with reference to FIG. 8.

As shown in FIG. 8, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 4. That is, a basic parameter table of the photographing lens assembly in the example is the same as Table 4. An aspheric coefficient table is the same as Table 5. The differences between the example and Example 4 lie in that at least some elements of the lens barrel, the first spacer P1, the second spacer P2, the third spacer P3, the fourth spacer P4, the fifth spacer P5, and the fifth auxiliary spacer P5b have different structure sizes.

### Example 6

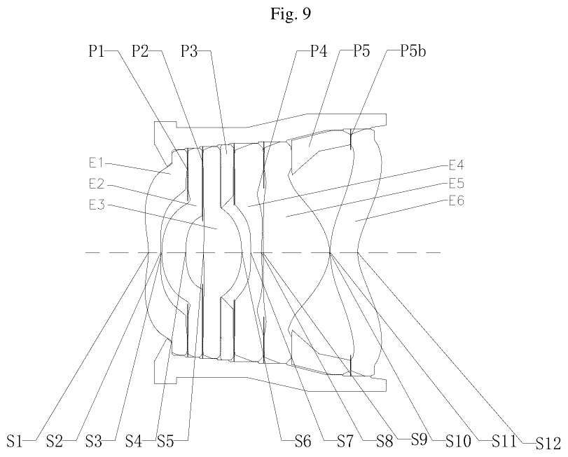

A photographing lens assembly according to Example 6 of the disclosure will be described below with reference to FIG. 9.

As shown in FIG. 9, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 4. That is, a basic parameter table of the photographing lens assembly in the example is the same as Table 4. An aspheric coefficient table is the same as Table 5. The differences between the example and Example 4 lie in that at least some elements of the lens barrel, the first spacer P1, the second spacer P2, the third spacer P3, the fourth spacer P4, the fifth spacer P5, and the fifth auxiliary spacer P5b have different structure sizes.

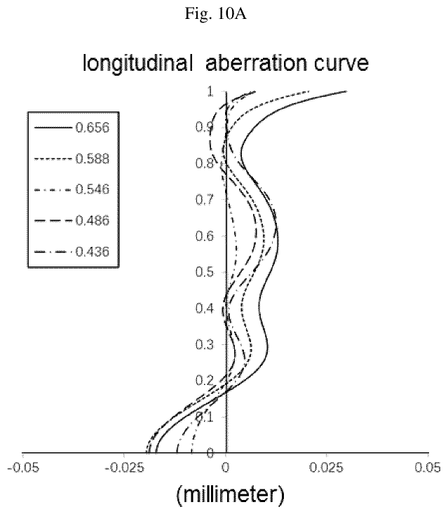

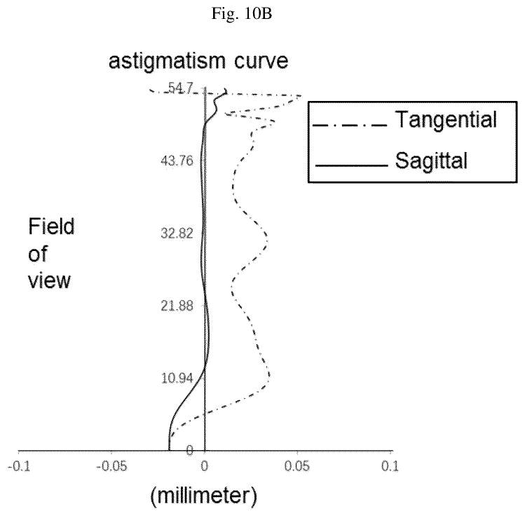

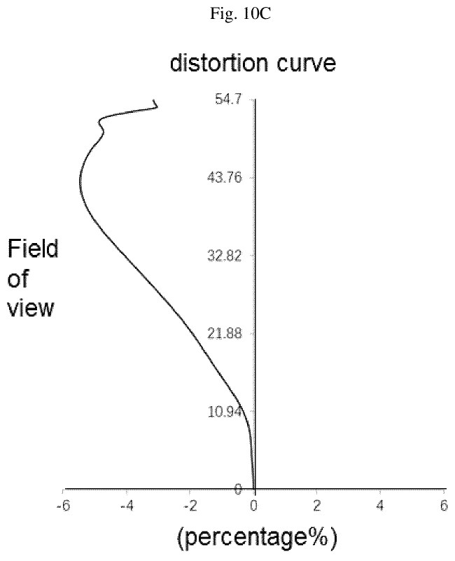

FIG. 10A shows longitudinal chromatic aberration curves of the photographing lens assembly in Examples 4, 5 and 6, which denote convergence focal point deviations after light having different wavelengths passes through the photographing lens assembly. FIG. 10B shows astigmatism curves of the photographing lens assembly in Examples 4, 5 and 6, which denote tangential image surface curvature and sagittal image surface curvature corresponding to different fields of view. FIG. 10C shows a distortion curve of the photographing lens assembly in Examples 4, 5 and 6, which denote distortion magnitude values corresponding to different fields of view. It can be seen from FIGS. 10A to 10C that excellent imaging quality is able to be achieved by the photographing lens assembly provided in Examples 4, 5, and 6.

### Example 7

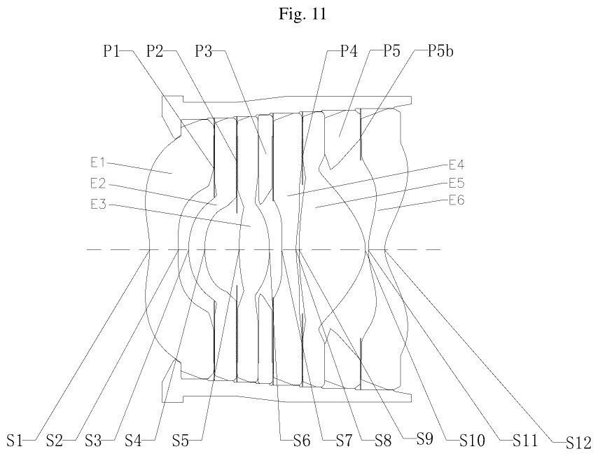

A photographing lens assembly according to Example 7 of the disclosure will be described below with reference to FIG. 11.

As shown in FIG. 11, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b. By the spacers, redundant light rays during imaging are able to be prevented from entering a next lens. Moreover, the lenses are able to better bear against the lens barrel, such that structural stability of the photographing lens assembly is enhanced.

The first lens E1 has a negative refractive power, an object-side surface S1 of the first lens is a concave surface, and an image-side surface S2 of the first lens is a convex surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a convex surface. The fourth lens E4 has a negative refractive power, an object-side surface S7 of the fourth lens is a convex surface, and an image-side surface S8 of the fourth lens is a concave surface. The fifth lens E5 has a positive refractive power, an object-side surface S9 of the fifth lens is a convex surface, and an image-side surface S10 of the fifth lens is a convex surface. The sixth lens E6 has a negative refractive power, an object-side surface S11 of the sixth lens is a convex surface, and an image-side surface S12 of the sixth lens is a concave surface. In an instance, an optical filter is arranged between the sixth lens E6 and an imaging surface S15 (not shown). The optical filter has an object-side surface S13 (not shown) and an image-side surface S14 (not shown). Light rays from an object pass through surfaces S1 to S14 in sequence to be finally imaged on the imaging surface S15.

Table 6 shows a basic parameter table of the photographing lens assembly in Example 7. Units of a curvature radius, a thickness/distance, and a focal length are millimeter (mm).

TABLE 6

| | | | | Material | | | |
|---|---|---|---|---|---|---|---|
| Surface | Surface | Curvature | Thickness/ | Refractive | Abbe | Focal | Cone |
| number | type | radius | distance | index | number | length | coefficient |
| OBJ | Spherical | Infinity | 2000.0000 | | | | |
| S1 | Aspheric | −2.6936 | 0.9545 | 1.535 | 55.8 | −8.00 | −11.33 |
| S2 | Aspheric | −8.1031 | 0.3383 | | | | −80.86 |
| S3 | Aspheric | 2.6934 | 0.5328 | 1.661 | 20.4 | 458.05 | 1.27 |
| S4 | Aspheric | 2.5020 | 1.0671 | | | | 2.23 |
| STO | Spherical | Infinity | 0.0754 | | | | |
| S5 | Aspheric | 5.8151 | 1.0044 | 1.544 | 56.1 | 4.25 | 4.53 |
| S6 | Aspheric | −3.6246 | 0.4040 | | | | 1.50 |
| S7 | Aspheric | 6.6679 | 0.4800 | 1.671 | 19.2 | −10.51 | −95.19 |
| S8 | Aspheric | 3.3475 | 0.1000 | | | | −8.24 |
| S9 | Aspheric | 10.6771 | 2.2000 | 1.544 | 56.1 | 2.13 | 0.53 |
| S10 | Aspheric | −1.2085 | 0.1000 | | | | −1.58 |
| S11 | Aspheric | 2.0954 | 0.5456 | 1.661 | 20.4 | −3.09 | −16.71 |
| S12 | Aspheric | 0.9314 | 0.9952 | | | | −3.99 |
| S13 | Spherical | Infinity | 0.2100 | 1.517 | 64.2 | | |
| S14 | Spherical | Infinity | 0.4000 | | | | |
| S15 | Spherical | Infinity | | | | | |

In the example, a value of a total effective focal length f of the photographing lens assembly is 2.53 mm. A value of an f-number FNO of the photographing lens assembly is 1.45. A value of a semi-maximum field of view Semi-FOV of the photographing lens assembly is 57.00°.

In the example, the object-side surface and the image-side surface of any one of the first lens E1 to the sixth lens E6 are aspheric surfaces. Table 7 gives coefficients A₄, A₆, A₈, A₁₀, A₁₂, A₁₄, A₁₆, A₁₈, A₂₀, A₂₂, A₂₄, A₂₆, A₂₈ and A₃₀ of high-order terms that may be used for aspheric surfaces S1 to S12 in Example 7.

TABLE 7

| Surface | | | | | | | |
|---|---|---|---|---|---|---|---|
| number | A4 | A6 | A8 | A10 | A12 | A14 | A16 |
| S1 | 5.08E−02 | −2.14E−02 | 8.14E−03 | −2.60E−03 | 6.95E−04 | −1.55E−04 | 2.85E−05 |
| S2 | 1.73E−01 | −1.02E−01 | 1.32E−02 | 1.14E−01 | −2.30E−01 | 2.68E−01 | −2.17E−01 |
| S3 | 8.58E−02 | −1.10E−01 | 7.98E−02 | 7.39E−02 | −3.26E−01 | 5.12E−01 | −4.91E−01 |
| S4 | 5.67E−02 | −4.83E−01 | 3.35E+00 | −1.54E+01 | 4.87E+01 | −1.09E+02 | 1.77E+02 |
| S5 | 1.54E−02 | −2.16E−01 | 1.37E+00 | −5.42E+00 | 1.42E+01 | −2.58E+01 | 3.31E+01 |
| S6 | −4.76E−02 | −5.50E−02 | 5.22E−01 | −2.15E+00 | 5.83E+00 | −1.11E+01 | 1.52E+01 |
| S7 | −9.25E−02 | 5.13E−02 | −3.70E−01 | 1.52E+00 | −3.71E+00 | 6.11E+00 | −7.10E+00 |
| S8 | −2.73E−02 | −7.82E−02 | 1.45E−01 | −1.52E−01 | 1.22E−01 | −8.34E−02 | 4.93E−02 |
| S9 | 4.53E−02 | −8.76E−02 | 7.68E−02 | −2.52E−02 | −1.75E−02 | 2.77E−02 | −1.84E−02 |
| S10 | 1.08E−01 | −1.14E−01 | 8.21E−02 | −4.59E−02 | 2.26E−02 | −1.17E−02 | 6.14E−03 |
| S11 | 7.02E−02 | −1.20E−01 | 1.14E−01 | −7.83E−02 | 3.83E−02 | −1.31E−02 | 3.07E−03 |
| S12 | −4.92E−03 | −1.61E−02 | 1.99E−02 | −1.70E−02 | 1.00E−02 | −4.07E−03 | 1.16E−03 |
| Surface | | | | | | | |
| number | A18 | A20 | A22 | A24 | A26 | A28 | A30 |
| S1 | −4.20E−06 | 4.81E−07 | −4.14E−08 | 2.57E−09 | −1.08E−10 | 2.74E−12 | −3.16E−14 |
| S2 | 1.27E−01 | −5.40E−02 | 1.66E−02 | −3.58E−03 | 5.15E−04 | −4.41E−05 | 1.70E−06 |
| S3 | 3.15E−01 | −1.39E−01 | 4.33E−02 | −9.67E−03 | 1.59E−03 | −1.86E−04 | 1.15E−05 |
| S4 | −2.09E+02 | 1.79E+02 | −1.11E+02 | 4.82E+01 | −1.39E+01 | 2.39E+00 | −1.86E−01 |
| S5 | −3.03E+01 | 1.98E+01 | −8.97E+00 | 2.72E+00 | −5.07E−01 | 4.84E−02 | −1.33E−03 |
| S6 | −1.51E+01 | 1.09E+01 | −5.65E+00 | 2.05E+00 | −4.94E−01 | 7.09E−02 | −4.58E−03 |
| S7 | 5.95E+00 | −3.62E+00 | 1.58E+00 | −4.84E−01 | 9.83E−02 | −1.19E−02 | 6.50E−04 |
| S8 | −2.43E−02 | 9.42E−03 | −2.72E−03 | 5.59E−04 | −7.65E−05 | 6.24E−06 | −2.30E−07 |
| S9 | 7.83E−03 | −2.31E−03 | 4.82E−04 | −7.02E−05 | 6.82E−06 | −3.98E−07 | 1.05E−08 |
| S10 | −2.70E−03 | 8.78E−04 | −2.01E−04 | 3.14E−05 | −3.17E−06 | 1.86E−07 | −4.86E−09 |
| S11 | −4.59E−04 | 3.36E−05 | 1.46E−06 | −6.18E−07 | 6.41E−08 | −3.18E−09 | 6.45E−11 |
| S12 | −2.37E−04 | 3.46E−05 | −3.58E−06 | 2.56E−07 | −1.21E−08 | 3.38E−10 | −4.23E−12 |

### Example 8

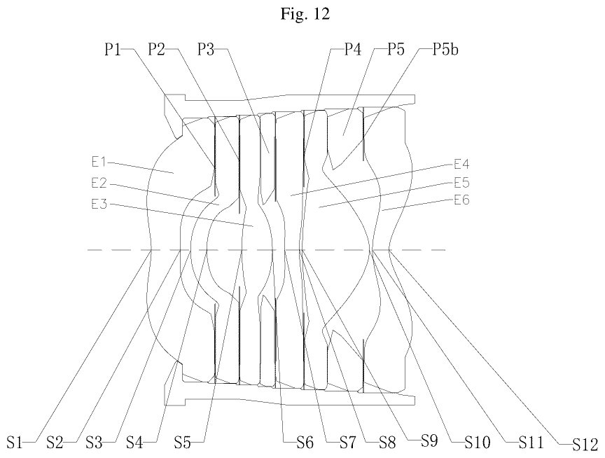

A photographing lens assembly according to Example 8 of the disclosure will be described below with reference to FIG. 12.

As shown in FIG. 12, the photographing lens assembly includes a lens barrel, and a six-piece lens group and a spacer group that are arranged in the lens barrel. The six-piece lens group includes a first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 7. That is, a basic parameter table of the photographing lens assembly in the example is the same as Table 6. An aspheric coefficient table is the same as Table 7. The differences between the example and Example 7 lie in that at least some elements of the lens barrel, the first spacer P1, the second spacer P2, the third spacer P3, the fourth spacer P4, the fifth spacer P5, and the fifth auxiliary spacer P5b have different structure sizes.

### Example 9

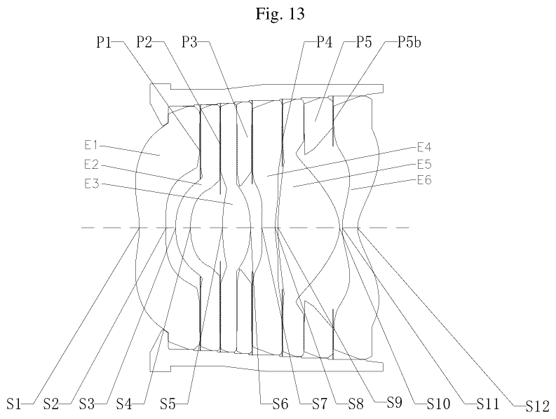

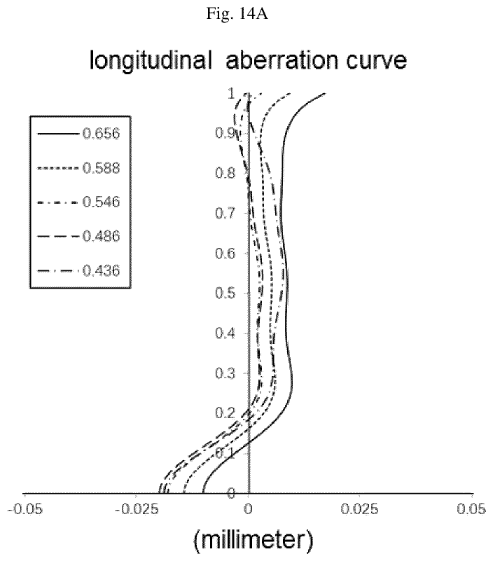

A photographing lens assembly according to Example 9 of the disclosure will be described below with reference to FIG. 13.

As shown in FIG. 13, the photographing lens assembly includes a lens barrel, and a six-piece lens group and a spacer group arranged in the lens barrel. The six-piece lens group includes A first lens E1, a second lens E2, a third lens E3, a fourth lens E4, a fifth lens E5, and a sixth lens E6 in sequence from an object side to an image side along an optical axis. A diaphragm STO is arranged between the second lens E2 and the third lens E3. The spacer group includes a first spacer P1, a second spacer P2, a third spacer P3, a fourth spacer P4, a fifth spacer P5, and a fifth auxiliary spacer P5b.

The structure of the lens in the example is the same as that of the lens in Example 7. That is, a basic parameter table of the photographing lens assembly in the example is the same as Table 6. An aspheric coefficient table is the same as Table 7. The differences between the example and Example 7 lie in that at least some elements of the lens barrel, the first spacer P1, the second spacer P2, the third spacer P3, the fourth spacer P4, the fifth spacer P5, and the fifth auxiliary spacer P5b have different structure sizes.

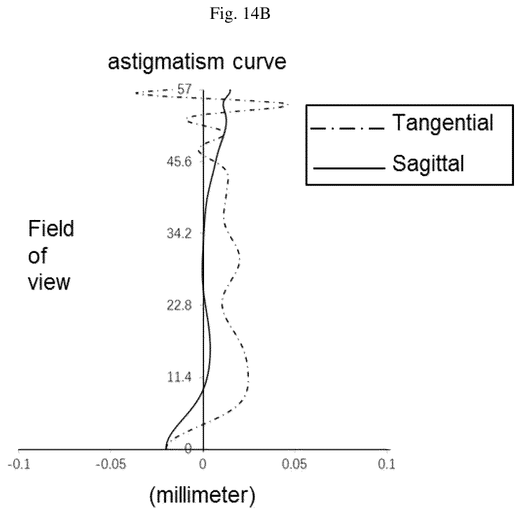

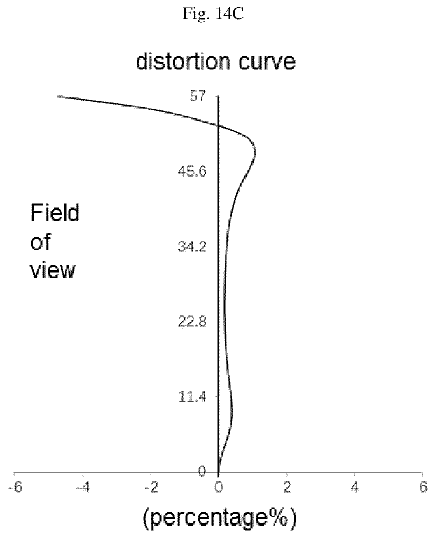

FIG. 14A shows longitudinal chromatic aberration curves of the photographing lens assembly in Examples 7, 8 and 9, which denote convergence focal point deviations after light having different wavelengths passes through the photographing lens assembly. FIG. 14B shows astigmatism curves of the photographing lens assembly in Examples 7, 8 and 9, which denote tangential image surface curvature and sagittal image surface curvature corresponding to different fields of view. FIG. 14C shows a distortion curve of the photographing lens assembly in Examples 7, 8 and 9, which denote distortion magnitude values corresponding to different fields of view. It can be seen from FIGS. 14A to 14C that excellent imaging quality is able to be achieved by the photographing lens assembly provided in Examples 7, 8, and 9.

Table 8 shows values of d1m, D1m, d2m, D2m, d3s, d3m, D3m, d4s, d5s, d5m, d5bs, EP01, EP12, CP2, EP23, CP3, EP34, EP45, CP5, L, SG52, SG61, DT52, DT61, and other parameters in each of Examples 1 to 9. The above parameters may be measured according to the labeling method shown in FIG. 1A or FIG. 1B, and units of parameters listed in Table 8 is mm.

TABLE 8

| | Example | | | | | | | | |
|---|---|---|---|---|---|---|---|---|---|
| Parameter | 1 | 2 | 3 | 4 | 5 | 6 | 7 | 8 | 9 |
| d1m | 3.526 | 3.552 | 3.596 | 3.285 | 3.338 | 3.290 | 3.316 | 3.422 | 3.385 |
| D1m | 7.597 | 7.657 | 7.717 | 6.581 | 6.641 | 6.701 | 8.449 | 8.509 | 8.569 |
| d2m | 2.107 | 2.107 | 2.107 | 2.022 | 2.022 | 2.022 | 2.324 | 2.324 | 2.324 |
| D2m | 7.697 | 7.857 | 7.917 | 6.681 | 6.741 | 6.801 | 8.549 | 8.609 | 8.669 |
| d3s | 6.595 | 6.495 | 6.395 | 5.391 | 5.231 | 5.510 | 7.309 | 7.249 | 7.189 |
| d3m | 4.145 | 6.412 | 6.312 | 5.367 | 5.207 | 5.486 | 7.285 | 7.225 | 7.165 |
| D3m | 7.704 | 7.785 | 7.867 | 6.625 | 6.648 | 6.708 | 8.493 | 8.553 | 8.613 |
| d4s | 4.172 | 4.088 | 4.256 | 3.991 | 3.936 | 4.120 | 4.148 | 4.014 | 4.262 |
| d5s | 5.208 | 6.280 | 6.180 | 4.969 | 5.219 | 5.390 | 6.081 | 6.479 | 6.542 |
| d5m | 7.448 | 7.388 | 7.328 | 6.826 | 6.902 | 6.942 | 7.080 | 7.020 | 6.960 |
| d5bs | 6.865 | 6.842 | 6.819 | 6.621 | 6.621 | 6.585 | 5.723 | 5.697 | 5.673 |
| EP01 | 1.274 | 1.234 | 1.284 | 1.108 | 1.138 | 1.089 | 1.726 | 1.646 | 1.788 |
| EP12 | 0.661 | 0.671 | 0.681 | 0.435 | 0.405 | 0.485 | 0.733 | 0.783 | 0.701 |
| CP2 | 0.018 | 0.018 | 0.018 | 0.018 | 0.018 | 0.018 | 0.018 | 0.018 | 0.018 |
| EP23 | 0.569 | 0.589 | 0.589 | 0.633 | 0.603 | 0.580 | 0.700 | 0.670 | 0.580 |
| CP3 | 0.537 | 0.497 | 0.477 | 0.343 | 0.393 | 0.440 | 0.484 | 0.494 | 0.542 |
| EP34 | 0.923 | 0.893 | 1.013 | 0.936 | 0.886 | 0.961 | 0.952 | 0.918 | 1.061 |
| EP45 | 0.741 | 0.821 | 0.721 | 0.930 | 0.980 | 0.910 | 0.733 | 0.757 | 0.760 |
| CP5 | 2.478 | 2.418 | 2.388 | 2.036 | 1.996 | 1.946 | 1.186 | 1.176 | 1.037 |
| L | 8.208 | 8.148 | 8.268 | 7.611 | 7.551 | 7.671 | 8.276 | 8.216 | 8.336 |
| SG52 | −1.598 | −1.558 | −1.558 | −1.306 | −1.286 | −1.256 | −1.350 | −1.380 | −1.276 |
| SG61 | 0.866 | 0.838 | 0.808 | 0.720 | 0.700 | 0.680 | −0.246 | −0.286 | −0.321 |
| DT52 | 2.16 | 2.16 | 2.16 | 2.14 | 2.14 | 2.14 | 2.18 | 2.18 | 2.18 |
| DT61 | 2.50 | 2.50 | 2.50 | 2.44 | 2.44 | 2.44 | 2.42 | 2.42 | 2.42 |

Table 9 shows values of conditional expressions in each of Examples 1 to 9.

TABLE 9

| | Example | | | | | | | | |
|---|---|---|---|---|---|---|---|---|---|
| Conditional expression | 1 | 2 | 3 | 4 | 5 | 6 | 7 | 8 | 9 |
| f1/f3 | −1.87 | −1.87 | −1.87 | −1.82 | −1.82 | −1.82 | −1.89 | −1.89 | −1.89 |
| f/(f5 + f6) | −1.68 | −1.68 | −1.68 | −1.38 | −1.38 | −1.38 | −2.64 | −2.64 | −2.64 |
| (EP45 + CP5)/(CT5 + T45) | 1.36 | 1.36 | 1.31 | 1.34 | 1.34 | 1.29 | 0.83 | 0.84 | 0.78 |
| CT5/EP45 | 3.16 | 2.86 | 3.25 | 2.35 | 2.23 | 2.41 | 3.00 | 2.91 | 2.89 |
| (f5 + f6)/d5bs | −0.23 | −0.23 | −0.23 | −0.30 | −0.30 | −0.30 | −0.17 | −0.17 | −0.17 |
| (d5s − d2m)/f345 | 1.27 | 1.71 | 1.67 | 1.27 | 1.38 | 1.45 | 1.53 | 1.69 | 1.71 |
| (CT2 + T23)/(EP12 + CP2) | 2.48 | 2.44 | 2.41 | 2.99 | 3.20 | 2.69 | 2.13 | 2.00 | 2.23 |
| (EP23 + CT3)/(T23 + T34) | 1.27 | 1.29 | 1.29 | 2.21 | 2.17 | 2.14 | 1.16 | 1.14 | 1.08 |
| CP3/(T34 + CT4) | 0.60 | 0.55 | 0.53 | 0.53 | 0.61 | 0.68 | 0.55 | 0.56 | 0.61 |
| L/f × FNO | 4.52 | 4.49 | 4.55 | 4.04 | 4.01 | 4.07 | 4.75 | 4.71 | 4.78 |
| (D2m − d2m)/(D3m − d3m) | 1.57 | 4.19 | 3.74 | 3.70 | 3.27 | 3.91 | 5.15 | 4.73 | 4.38 |
| EP01/(CT1 + T12) | 1.77 | 1.71 | 1.78 | 2.52 | 2.58 | 2.47 | 1.34 | 1.27 | 1.38 |
| D3m/(EP34 + CT3) | 3.99 | 4.09 | 3.89 | 3.02 | 3.10 | 3.02 | 4.34 | 4.45 | 4.17 |
| f1/R2 | 0.96 | 0.96 | 0.96 | 1.64 | 1.64 | 1.64 | 0.99 | 0.99 | 0.99 |
| D1m/d1m | 2.15 | 2.16 | 2.15 | 2.00 | 1.99 | 2.04 | 2.55 | 2.49 | 2.53 |
| f4/f3 + d4s/d3s | −1.15 | −1.15 | −1.12 | −0.66 | −0.65 | −0.65 | −1.91 | −1.92 | −1.88 |
| d5s/DT52 + d5m/DT61 | 5.39 | 5.86 | 5.79 | 5.12 | 5.26 | 5.36 | 5.72 | 5.87 | 5.88 |
| (\|SG52\| + \|SG61\|)/CT5 | 1.05 | 1.02 | 1.01 | 0.93 | 0.91 | 0.88 | 0.73 | 0.76 | 0.73 |

The disclosure further provides an imaging apparatus. An electronic photosensitive element may be a charge coupled device (CCD) or a complementary metal oxide semiconductor (CMOS). The imaging apparatus may be a stand-alone imaging apparatus, such as a digital camera, or an imaging module integrated on a mobile electronic device, such as a cell phone. The imaging apparatus is equipped with the photographing lens assembly described above.

The above description is merely illustrative of preferred examples of the disclosure and of principles of the technology employed. It should be understood by a person skilled in the art that the scope of invention involved in the disclosure is not limited to the technical solution formed by a specific combination of the above technical features, and should cover other technical solutions formed by any combinations of the above technical features or their equivalent features without departing from the inventive concept, for instance, the technical solution formed by replacing the above features with the technical features having similar functions disclosed in (but not limited to) the disclosure or vice versa.

What is claimed is:

1. A photographing lens assembly, comprising:
a six-piece lens group, wherein the six-piece lens group comprises a first lens having a negative refractive power, a second lens having a positive refractive power, a third lens having a positive refractive power, a fourth lens having a negative refractive power, a fifth lens having a positive refractive power, and a sixth lens having a negative refractive power that are arranged in sequence from an object side to an image side along an optical axis;
a spacer group, wherein the spacer group comprises a fourth spacer arranged on and in contact with an image-side surface of the fourth lens and a fifth spacer arranged on and in contact with an image-side surface of the fifth lens; and
a lens barrel, wherein the six-piece lens group and the spacer group are arranged in the lens barrel; wherein
a spacing distance between a non-effective diameter portion of the fifth lens and a non-effective diameter portion of the sixth lens in a direction along the optical axis is greater than a spacing distance between non-effective diameter portions of any two adjacent lenses from the first lens to the fifth lens in the direction along the optical axis;
an effective focal length f1 of the first lens and an effective focal length f3 of the third lens satisfy: −1.89≤f1/f3≤−1.82;
a total effective focal length f of the photographing lens assembly, an effective focal length f5 of the fifth lens, and an effective focal length f6 of the sixth lens satisfy: −2.64≤f/(f5+f6)≤−1.38;
a center thickness CT5 of the fifth lens on the optical axis and a spacing EP45 between the fourth spacer and the fifth spacer along the optical axis satisfy: 2.2<CT5/EP45≤3.25; and
an air spacing T45 between the fourth lens and the fifth lens on the optical axis, the center thickness CT5 of the fifth lens on the optical axis, the spacing EP45 between the fourth spacer and the fifth spacer along the optical axis, and a maximum thickness CP5 of the fifth spacer along the optical axis satisfy: 0.78≤(EP45+CP5)/(CT5+T45)<1.4.

2. The photographing lens assembly according to claim 1, wherein the spacer group further comprises a first spacer arranged on and in contact with an image-side surface of the first lens; and
a spacing EP01 between an object-side end surface of the lens barrel and the first spacer along the optical axis, a center thickness CT1 of the first lens on the optical axis, and an air spacing T12 between the first lens and the second lens on the optical axis satisfy: 1.27≤EP01/(CT1+T12)≤2.58.

3. The photographing lens assembly according to claim 1, wherein the spacer group further comprises a first spacer arranged on and in contact with an image-side surface of the first lens; an effective focal length f1 of the first lens and a curvature radius R2 of the image-side surface of the first lens satisfy: 0.96≤f1/R2≤1.64; and an inner diameter d1m of an image-side surface of the first spacer and an outer diameter D1m of the image-side surface of the first spacer satisfy: 1.99≤D1m/d1m<2.6.

4. The photographing lens assembly according to claim 1, wherein the spacer group further comprises a second spacer arranged on and in contact with an image-side surface of the second lens; and
a combined focal length f345 of the third lens, the fourth lens, and the fifth lens, an inner diameter d2m of an image-side surface of the second spacer, and an inner diameter d5s of an object-side surface of the fifth spacer satisfy: 1.27≤(d5s−d2m)/f345≤1.71.

5. The photographing lens assembly according to claim 1, wherein the spacer group further comprises a first spacer arranged on and in contact with an image-side surface of the first lens and a second spacer arranged on and in contact with an image-side surface of the second lens; and a center thickness CT2 of the second lens on the optical axis, an air spacing T23 between the second lens and the third lens on the optical axis, a spacing EP12 between the first spacer and the second spacer along the optical axis, and a maximum thickness CP2 of the second spacer along the optical axis satisfy: 2.00≤(CT2+T23)/(EP12+CP2)≤3.20.

6. The photographing lens assembly according to claim 1, wherein the spacer group further comprises a second spacer arranged on and in contact with an image-side surface of the second lens and a third spacer arranged on and in contact with an image-side surface of the third lens; and
an air spacing T23 between the second lens and the third lens on the optical axis, a center thickness CT3 of the third lens on the optical axis, an air spacing T34 between the third lens and the fourth lens on the optical axis, and a spacing EP23 between the second spacer and the third spacer along the optical axis satisfy: 1.08≤(EP23+CT3)/(T23+T34)≤2.21.

7. The photographing lens assembly according to claim 1, wherein the spacer group further comprises a second spacer arranged on and in contact with an image-side surface of the second lens and a third spacer arranged on and in contact with an image-side surface of the third lens; and
an inner diameter d2m of an image-side surface of the second spacer, an outer diameter D2m of the image-side surface of the second spacer, an inner diameter d3m of an image-side surface of the third spacer, and an outer diameter D3m of the image-side surface of the third spacer satisfy: 1.57≤(D2m−d2m)/(D3m−d3m)≤5.15.

8. The photographing lens assembly according to claim 1, wherein the spacer group further comprises a third spacer arranged on and in contact with an image-side surface of the third lens; and
an air spacing T34 between the third lens and the fourth lens on the optical axis, a center thickness CT4 of the fourth lens on the optical axis, and a maximum thickness CP3 of the third spacer along the optical axis satisfy: 0.53≤CP3/(T34+CT4)≤0.68.

9. The photographing lens assembly according to claim 1, wherein the spacer group further comprises a third spacer arranged on and in contact with an image-side surface of the third lens; and
a center thickness CT3 of the third lens on the optical axis, an outer diameter D3m of an image-side surface of the third spacer, and a spacing EP34 between the third spacer and the fourth spacer along the optical axis satisfy: 3.0<D3m/(EP34+CT3)<4.5.

10. The photographing lens assembly according to claim 1, wherein the spacer group further comprises a third spacer arranged on and in contact with an image-side surface of the third lens; and
an effective focal length f3 of the third lens, an effective focal length f4 of the fourth lens, an inner diameter d3s of an object-side surface of the third spacer, and an inner diameter d4s of an object-side surface of the fourth spacer satisfy: −1.92≤f4/f3+d4s/d3s≤−0.65.

11. The photographing lens assembly according to claim 1, wherein the spacer group further comprises a fifth auxiliary spacer arranged on and in contact with an image-side surface of the fifth spacer; and
the effective focal length f5 of the fifth lens, the effective focal length f6 of the sixth lens, and an inner diameter d5bs of an object-side surface of the fifth auxiliary spacer satisfy: −0.30≤(f5+f6)/d5bs≤−0.17.

12. The photographing lens assembly according to claim 1, wherein a maximum length L of the lens barrel in the direction along the optical axis, the total effective focal length f of the photographing lens assembly, and an f-number FNO of the photographing lens assembly satisfy: 0.01≤L/f×FNO<4.8.

13. The photographing lens assembly according to claim 1, wherein a maximum effective semi-diameter DT52 of the image-side surface of the fifth lens, a maximum effective semi-diameter DT61 of an object-side surface of the sixth lens, an inner diameter d5s of an object-side surface of the fifth spacer, and an inner diameter d5m of an image-side surface of the fifth spacer satisfy: 5.12≤d5s/DT52+d5m/DT61≤5.88.

14. The photographing lens assembly according to claim 1, wherein a distance SG52 from an intersection point between the image-side surface of the fifth lens and the optical axis to an object-side surface of the fifth spacer on the optical axis, a distance SG61 from an intersection point between an object-side surface of the sixth lens and the optical axis to an image-side surface of the fifth spacer on the optical axis, and the center thickness CT5 of the fifth lens on the optical axis satisfy: 0.73≤(|SG52|+|SG61|)/CT5<1.1.

15. The photographing lens assembly according to claim 1, wherein
an object-side surface of the first lens is a concave surface, and an image-side surface of the first lens is a convex surface;
an object-side surface of the second lens is a convex surface, and an image-side surface of the second lens is a concave surface;
an object-side surface of the third lens is a convex surface, and an image-side surface of the third lens is a convex surface;
an object-side surface of the fourth lens is a convex surface, and the image-side surface of the fourth lens is a concave surface;
the image-side surface of the fifth lens is a convex surface; and
an object-side surface of the sixth lens is a convex surface, and an image-side surface of the sixth lens is a concave surface.
